(19) United States
(12) Patent Application Publication
(10) Pub. No.: US 2024/0272366 A1
(43) Pub. Date: Aug. 15, 2024

(54) BACKSIDE OPTICAL COUPLER

(71) Applicant: University of Southern California, Los Angeles, CA (US)

(72) Inventors: Sujith Chandran, Clifton Park, NY (US); Ajey P. Jacob, Watervliet, NY (US); Akhilesh Jaiswal, Madison, WI (US); Ramesh Kudalippalliyalil, College Park, MD (US); Sugeet Sunder, Los Angeles, CA (US)

(21) Appl. No.: 18/430,372

(22) Filed: Feb. 1, 2024

Related U.S. Application Data
(60) Provisional application No. 63/442,703, filed on Feb. 1, 2023.

(30) Foreign Application Priority Data
Oct. 10, 2023 (KR) 10-2023-0134176

(51) Int. Cl. G02B 6/30; G02B 6/34

(52) U.S. Cl. CPC G02B 6/30; G02B 6/34

(57) ABSTRACT

Provided is an optical coupler comprising: an optical fiber housing, the housing configured to accept one or more optical fiber pigtails and the housing mechanically coupled to a backside of an integrated circuit chip; a grating coupler, the grating coupler optically coupled to an output of the one or more optical fiber pigtails of the fiber optic cable housing; and a waveguide, the waveguide optically coupled to an output of the grating coupler, and method of forming same.

### CROSS-REFERENCE TO RELATED APPLICATIONS

This application claims the benefit of U.S. Provisional Application 63/442,703, titled “BACKSIDE OPTICAL COUPLER”, filed 1 Feb. 2023, and Patent Application No. 10-2023-0134176 in the Republic of Korea, titled “BACKSIDE OPTICAL COUPLER”, filed 10 Oct. 2023. The entire contents of each afore-mentioned patent filing is hereby incorporated by reference.

### BACKGROUND

This disclosure relates generally to the field of optical interconnects and more particularly to interconnects for coupling of optical fibers and waveguides.

Photonic integrated circuits (PICs) are integrated circuits which may operate based on optical signals, including optical signals which may be transmitted between components (e.g., optical source, resonators, optoelectronic couplers) via waveguides (e.g., integrated waveguides). The waveguides of a PIC may transmit optical signals sufficiently efficiently between elements of within an integrated circuit, but may be non-ideal (due to brittleness, optical losses, etc.) for transmission of optical signals between PICs, between non-integrated circuitry (e.g., between an external optical source and a PIC), over distances longer than a chip length (e.g., between remote PICs, between elements separated by more than a coherence length, etc.), etc. Optical fibers may be well-suited to transmit optical signals over longer distances—such as up to telecommunication distances and beyond—and over more diverse conditions, such as high temperature (e.g., geological temperatures), high pressure (e.g., geological pressures), low temperature (e.g., cryogenic temperatures), etc. and with greater physical strength, flexibility, and resiliency (e.g., than integrated waveguides). However, transferring an optical signal from an optical fiber to a PIC waveguide (and vice versa) may result in signal strength loss (e.g., due to size mismatch) or may require precision alignment (which may be expensive). Efficient (in both cost and signal preservation) and mechanically stable optical couplers are in high demand to integrate PICs (such as for quantum computing, and other applications) and optical fibers to provide fast, low-cost, optical signal transmission over distances and between PICs in various locations.

Low-loss (e.g., efficient) optical input/output (I/O) may be desired for optical devices, such as PICs. Grating couplers on the top side of the wafer or edge couplers operating in V-grooves (e.g., V shaped grooves etched into a wafer face) may provide some solutions, but they may suffer from high-accuracy alignment requirements, which may lead to high implementation costs, low mechanical strength, and efficiency deficits. No single optical fiber to waveguide technology has emerged as an industry wide standard. None of which is to suggest that any technique suffering to some degree from these issues is disclaimed or that any other subject matter is disclaimed.

While the present techniques are susceptible to various modifications and alternative forms, specific embodiments thereof are shown by way of example in the drawings included or described herein. The drawings may not be to-scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### SUMMARY

The following is a non-exhaustive listing of some aspects of the present techniques. These and other aspects are described in the following disclosure.

Some aspects include a photonic integrated circuit (PIC).

Some aspects include a backside optical coupler, such as for coupling an optical fiber to a PIC.

Some aspects include an optical fiber coupled to one or more pig tails attached through a V-groove, such as a V-groove etched in the backside of a wafer.

Some aspects include a grating structure, including a one-dimensional grating, two-dimensional grating, point grating, etc.

Some aspects include one or more mirrors, such as distributed Bragg reflector (DBR) mirrors. Some aspects include one or more mirrors to reflect light transmitted by a grating structure, such as to reflect transmitted light back toward the grating, optical fiber, backside of the wafer, etc.

Some aspects include one or more photonic crystals, including photonic crystal waveguides, photonic crystal grating structures, photonic crystal resonator cavities, etc.

Some aspects include one or more metamaterial structures, such as antireflection metamaterials, negative-index metamaterials, etc.

Some aspects include combinations of photonic crystals and metamaterials, including photonic crystals fabricated on metamaterial structures.

Some aspects include an anti-reflective (AR) coating.

Some aspects include a PIC consisting of the optical coupler, an optical fiber, and a laser, including an integrated module containing the optical couple, optical fiber, and laser (or other optical source).

Some aspects include one or more methods of fabricating the above, including by monolithic or heterogeneous integration.

Some aspects include a pigtail attached to a fiber housing connected to the PIC by a V-groove etched in the backside of the wafer.

Some aspects include one or more of operating the above, including by transmitting an optical signal, detecting an optical signal, etc.

Some aspects include cryogenic capabilities. Some aspects include quantum coherence preservation, such as by maintaining quantum coherence between optical signals of optical fibers and waveguides.

Some aspects include electrical interconnects, which may be backend of line (BOEL), front side, etc. Some aspects include chip to chip bonding, such as of the BOC to an electrical chip, which may use solder bumps, metallization, through silicon vias (TSVs), etc.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1A is a schematic representation of a cross-sectional view of an exemplary backside optical coupler (BOC) in relationship to a waveguide and an optical fiber, in accordance with one or more embodiments.

FIG. 1B is a graph depicting Fresnel reflectance and transmittance at interfaces between silicon and silicon dioxide as a function of incident angle, in accordance with one or more embodiments.

FIG. 1C is a is a schematic representation of a cross-sectional view of an exemplary backside optical coupler (BOC) in relationship to a waveguide and an optical fiber with silica fill, in accordance with one or more embodiments.

FIGS. 2A-2C depict various views of a BOC with metamaterial structures and a power combiner, in accordance with one or more embodiments.

FIGS. 3A-3C depict various views of a BOC with an antireflection coating and a power combiner, in accordance with one or more embodiments.

FIGS. 4A-4C depict various views of a BOC with a focusing grating coupler and metamaterial structures, in accordance with one or more embodiments.

FIGS. 5A-5C depict various views of a BOC with a focusing grating coupler and an antireflection coating, in accordance with one or more embodiments.

FIGS. 6A-6C depict various views of a BOC with a focusing grating coupler, in accordance with one or more embodiments.

FIGS. 7A-7B depict various views of BOCs with a focusing grating coupler and multiple reflective coatings, in accordance with one or more embodiments.

FIG. 8 depicts a cross-sectional view of a graded index V-groove fill for fiber integrations in a BOC, in accordance with one or more embodiments.

FIG. 9 depicts a PIC with fiber pig tails attached by BOCs integrated into a package, in accordance with one or more embodiments.

FIG. 10 depicts a co-packaging structure for a BOC with fiber pig tails attached to a packaged PIC, in accordance with one or more embodiments.

FIG. 11 depicts a relationship between the co-packaged optics of FIG. 10 and the exemplary BOC of FIG. 1A, in accordance with one or more embodiments.

FIG. 12 depicts a schematic representation of optical signal transmission through a BOC, in accordance with one or more embodiments.

FIG. 13 is a system diagram that illustrates an example optical computing system using a BOC, in accordance with one or more embodiments.

FIG. 14 depicts graphs of layer thickness for an exemplary BOC, according to one or more embodiments.

FIG. 15 depicts a graph of coupling efficiency versus wavelength for an exemplary BOC, according to one or more embodiments.

FIG. 16 depicts a graph of coupling efficiency versus the angle of incidence on the grating for an exemplary BOC, according to one or more embodiments.

FIG. 17 depicts graphs of coupling efficiency versus grating pitch and grating duty cycle for an exemplary BOC, according to one or more embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of optical couplers. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Edge coupling between waveguides and optical fibers, in which an optical fiber is coupled edge-on into a waveguide and in which the optical transmission mediums experience a size mismatch, such as using spot-size converters and lensed fibers, may be used for efficient coupling, such as with an insertion loss below 0.5 dB. However, edge couplers may only be used at the edge of the chips (including edge-faces created by etching into the body of the chip in which the edge faces are substantially perpendicular to the transmission direction of the optical fiber) and implementing them requires complicated post-processing and high-resolution optical alignment, which may increase packaging cost.

Grating couplers have been used to overcome some of these disadvantages, but may introduce different drawbacks, such as causing lower coupling efficiencies and decreasing mechanical stability. The absence of post-processing in the fabrication of grating couplers (which may be fabricated substantially in-plane), and the flexibility of positioning of gratings may enable wafer-scale automated testing and keep the cost of manufacturing low.

In some embodiments, a backside optical coupler (BOC) may provide backside (e.g., substrate-side) coupling between the optical fiber and the waveguide, which may allow the surface (e.g., fabrication face) of the wafer to remain clutter free—e.g., free from optical fiber connections and available for electrical connection, device fabrication, etc. The BOC may operate based on a V-groove etched in the backside of the wafer. As used herein “wafer”, “chip”, “chiplet”, and “device” may be used to refer to a unit of integrated circuitry, where wafer may represent a fabrication unit while chip and chiplet may represent portions of a wafer, such as diced wafers, which may or may not be packaged. Device may refer to an element of circuitry smaller than a chip—for example, a chip may contain multiple devices or elements, such as a waveguide, an optical source (e.g., laser), etc. It should be understood that the techniques and devices described herein may be used with smaller or larger circuitry units without alteration (or with minimum alteration). Any reference to a wafer, chip, chiplet, or device should be understood to encompass application to a larger or smaller integrated circuit unit. Additionally, the BOC may be integrated with the wafer or the optical fiber. Elements of the BOC may be described as being part of the BOC, part of the optical fiber, part of the wafer, etc. The division between the optical fiber and the BOC and between the wafer and the BOC may be indistinct, and elements of each may be described as included in another unit or overlapping unit.

In some embodiments, the BOC may include or be attached to an etched area on the backside of a wafer (where the backside may or may not be a fabrication side). In some embodiments, the BOC may attach to a V-groove or frustrum which may be selectively etched, such as using reactive ion etching (REI), etched anisotropically, etched selectively along one or more plane of the material of the substrate (e.g., along the <111> plane of silicon for a silicon substate), etc. The etching may include etching away (e.g., substantially complete removal) of a backside substrate, such as silicon, which may allow coupling of an optical fiber, such as a silica fiber, to a buried layer on the substrate, such as a back oxide (BOX), buried oxide (for example, of a silicon-on-insulator wafer) or other layer, including an index-matched layer (which may be an intermediate layer before a BOX layer, between a BOX and top oxide (TOX) layer, etc.

In some embodiments, the BOC may contain one or more pigtail fiber housing, including an array of pigtail fiber housings. In some embodiments, the fiber housings may include fiber housings for high fan-in, multiple optical fibers, etc. The fiber housing may provide mechanical support and stability, including by introducing fibers through one or more ports. The housing may be configured to accept one or more single mode fibers (SMF), multi-mode fibers, etc. The housing may be configured to accept a fiber optic cable or a set of optical fibers, including N optical fibers, such as arrayed in an n by m array (or another close packing array of N optical fibers, including an array in which interstitial or other elements (such as filler elements) are included). In some embodiments, a pigtail array fiber housing may consist of a housing accepting one or more optical fibers. The pigtail array fiber housing may consist of an array of fiber housings, each of which may accept one or more optical fiber. In some embodiments, the fiber housings may consist of an adiabatic multi-fiber taper, which may have a width at a junction with one or more optical fiber which is greater than the width (e.g., cross-sectional area) of the one or more optical fiber. The adiabatic multi-fiber taper may decrease in width (e.g., cross-sectional area) towards the bulk of the BOC or backside of the wafer, including decreasing to a width (e.g., cross-sectional arca) smaller than that of the one or more optical fibers (either alone or together). The adiabatic multi-fiber taper may join a V-groove (e.g., a filled V-groove). In some embodiments, the adiabatic multi-fiber taper may be (e.g., join, terminate in, etc.) a graded-index doped silica (or other index matched) material, which may join the fiber housing to an optical layer, such as an optical layer within a coherence length of the grating. In some embodiments, the graded-index doped silica may decrease in width (e.g., cross-sectional area) towards the bulk of wafer (e.g., towards the grating). The fiber housing may have a decreasing cross-sectional area (for example, a linear taper, an adiabatic taper, etc.) when viewed from the one or more optical fiber pigtails towards the grating.

In some embodiments, the BOC may contain a rib waveguide grating, such as a waveguide taper, which may improve optical coupling efficiency. In some embodiments, the BOC may include one or more mirrors (e.g., reflectors), including all-dielectric distributed Bragg reflector (DBR) mirrors, such as for to improve efficiency of light trapping (e.g., decreasing optical transmission). In some embodiments, the mirrors may be silicon dioxide and silicon nitride (SiO₂/Si₃N₄) alternating layers in DBR configurations. The mirrors may trap (e.g., reflect) light, but may not affect device integration. That is, DBR mirrors may be integrated into wafer and BOC fabrication.

In some embodiments, the BOC maybe fabricated on a substrate, which may include a waveguide or other optical elements, and have one or more elements which may be made of silicon (Si), silicon nitride (SiN), silicon on insulator (SOI), silicon dioxide (SiO₂), aluminum nitride (AlN), etc. The substrate may be a group IV semiconductor (e.g., Si, Ge, etc.), including a highly doped group IV semiconductor, such as a semiconductor lattice matched to one or more other material. The substrate may be a direct or indirect bandgap semiconductor. The substrate may alternatively or additionally include one or more group III-V (e.g., GaAs, AlN, etc.) or group II-VI semiconductors (e.g., CdTe, ZnS, etc.), or any other appropriate semiconductor. The one or more mirrors may be SiO₂, SiN, aluminum and aluminum oxide (Al/AlO₂/Al), etc. thin films in DBR configurations. One or more reflectors of the BOC may be aluminum (Al) metallic reflectors, copper (Cu) metallic reflectors, etc. In some embodiments, one or more reflectors may be metamaterial reflectors, including reflectors with negative refractive indexes over a frequency range which may include a frequency of an optical signal.

In some embodiments, the BOC may include a grating, including a grating coupler, a waveguide, including a rib waveguide, ridge waveguide, buried channel waveguide, strip-loaded waveguide, diffused waveguide, a bus waveguide, etc., one or more reflector, such as a Bragg reflector, photonic crystal(s), metamaterial structures, one or more V-groove or frustrum, a pigtail, a pigtail array, and may be integrated into a backside of a wafer, a backend of line (BOEL), or other non-edge area.

In some embodiments, the BOC may provide additional surface area for fabrication, integration, access, etc. on the front side of the wafer, such as relative to a topside fiber coupling. The integration of the optical fiber into the backside of the wafer may allow additional surface area to be used for device fabrication, contacting of devices (e.g., electrical contacting, physical and optical contacting for sensors or sensor pixels), etc. In some embodiments, the BOC may provide additional mechanical stability to a connection between an optical fiber and a waveguide, such as through an integration (e.g., of a dedicated) fiber housing. The depth of the fiber housing may be substantially equivalent to the depth of the bulk of the wafer (e.g., substrate), which may provide mechanical stability against shear stress and strain, especially shear stress and strain along the plane of the wafer. The BOC may include a pigtail array, which may integrate one or more optical fiber pigtails, including mechanically, into the backside of the wafer. In some embodiments, the BOC may provide increased efficiency in optical coupling, relative to other topside grating couplers. The use of all-dielectric mirrors, such as all-dielectric DBR mirrors, may allow for active electrical interconnects to be used on the wafer in addition to the BOC—where the all-dielectric mirrors may be surface coatings, such as on the frontside of the wafer, which, because they are dielectrics, may still allow for active electrical contact to be made to the frontside of the wafer (e.g., by spot etching through dielectrics, by impedance connections, etc.). In some embodiments, the BOC may be fabricated using some standard processes, including in non-standard manners and combinations, which may offer low cost and well-characterized fabrication avenues.

In some embodiments, the BOC may be used as an interposer or as part of an interposer, such as in an opto-electronic interconnect. The BOC may operate, such as in a dilution refrigerator, to connect one or more optical fiber to an electronic device, such as a quantum computing devices, superconducting qubits, etc. The BOC may operate to receive and transmit optical signals between one or more opto-electronic transducers and one or more optical fiber, such as while maintaining quantum coherence of the optical signals. The BOC may be bonded, such as chip-to-chip bonded, to one or more opto-electronic device or integrated with one or more opto-electronic device, such as an opto-electronic transducer.

In some embodiments, in the BOC the fiber may be placed in a fiber housing on the substrate side. The light from the fiber may then be injected bottom-up through the substrate and coupled into the SOI waveguide using a grating. A highly reflective all-dielectric DBR mirror may be placed on the top of the grating, separated from the grating with a silica (˜SiO₂) buffer, to capture and reflect the fraction of light (e.g., optical signal) coupled into the transmission orders of the grating (e.g., light transmitted by the grating). In some embodiments, the proposed structure may have a higher mechanical stability, higher fan-in capacity, lesser topside clutter (e.g., fewer topside elements), and competing coupling efficiencies to existing topside grating couplers. Initial results for some embodiments show a promising coupling efficiency of −1.25 dB and a polarization-dependent loss of −0.8 dB. Other embodiments may result in reduced polarization loss further and may improve the overall coupling efficiency (e.g., relative to both initial results and existing topside grating couplers).

Light input/output (I/O) between on-chip waveguides (such as silicon waveguides) and optical fibers may be facilitated by a grating coupler or an edge coupling mechanism. The extensive refractive index n and feature size contrast between the silicon (n=3.47 at 1550 nm) and the silica (n=1.444 at 1550 nm) may translate to an order of magnitude contrast in the mode field diameters (MFD), which is a measure of the intensity profile of light and its diameter in the media, between the two media. The cross-sectional area of a typical SMF core may be almost 600 times larger than that of a standard silicon waveguide. Hence, the I/O coupling may require facilitating technologies that adjust the mode-field diameter accordingly.

Several approaches have been demonstrated to attempt to overcome the problem of mode mismatch between optical fibers and silicon waveguides, such as edge coupling using spot-size converters and lensed fibers-which have been reported to have coupling with an insertion loss below 0.5 dB. However, edge-coupling may only be used at the edge of the chips, and implementing such designs may require complicated post-processing (e.g., packaging, interposer use, etc.) and high-resolution optical alignment of fabricated chips, which may increase the packaging cost. Another approach of using grating couplers may have several advantages: alignment to grating couplers may be much easier than alignment to edge couplers; the absence of post-processing in fabrication; and the flexibility of positioning enables wafer-scale automated testing and keeps the cost of manufacturing relatively lower. Grating couplers with insertion loss below 1 dB have been demonstrated, and polarization splitting grating couplers have also been demonstrated.

The main factors inhibiting efficiency in a conventional grating coupler may be penetration loss, mode mismatch, and back reflection, where penetration loss may refer to the ratio of power lost to the substrate versus conveyed to the power coupler into the Silicon waveguide. A conventional grating coupler may lack the physical infrastructure to house optical fibers, which may be a significant factor when considering angle-sensitive coupling efficiencies (for example, as lack of a housing may lead to physical variations in angular relationship between elements). Optical testing may rely on polarization control, the health of the fragile fiber probes, as well as stringent positional requirements. A topside coupler may occupy much topside space, which may adversely affect component integration in traditional device packaging.

In some embodiments, the BOC consists of an optical I/O design that features a mechanically stable fiber housing, high fan-in capabilities, and design options on the backside of the wafer. This design may provide less clutter on the topside and edges of the chip, allowing flexible fiber-to-device integration with competitive coupling efficiency.

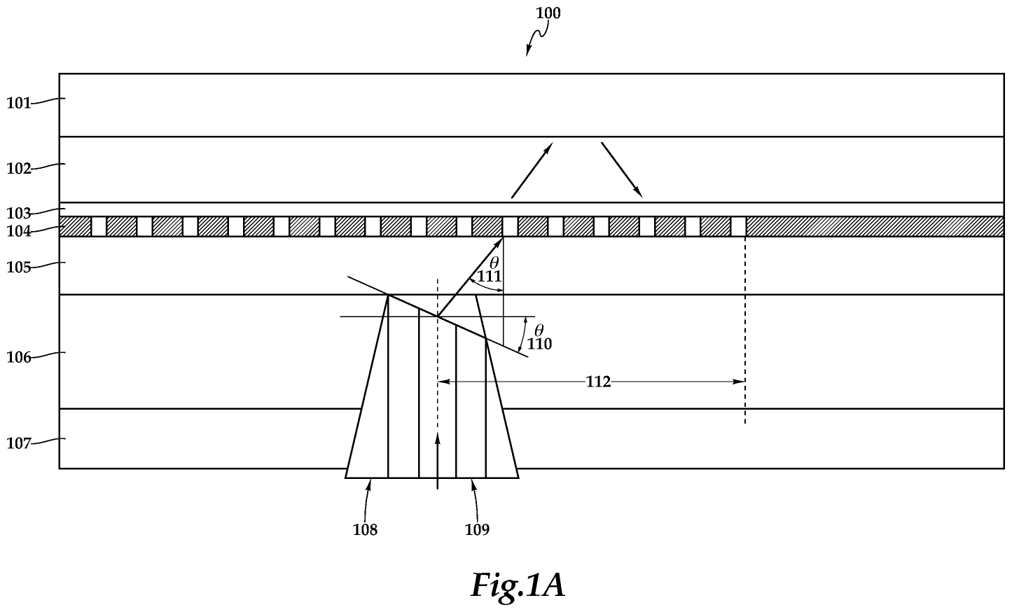

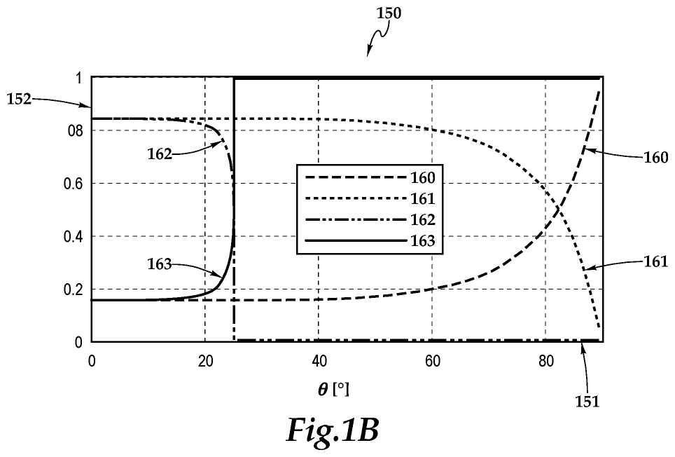

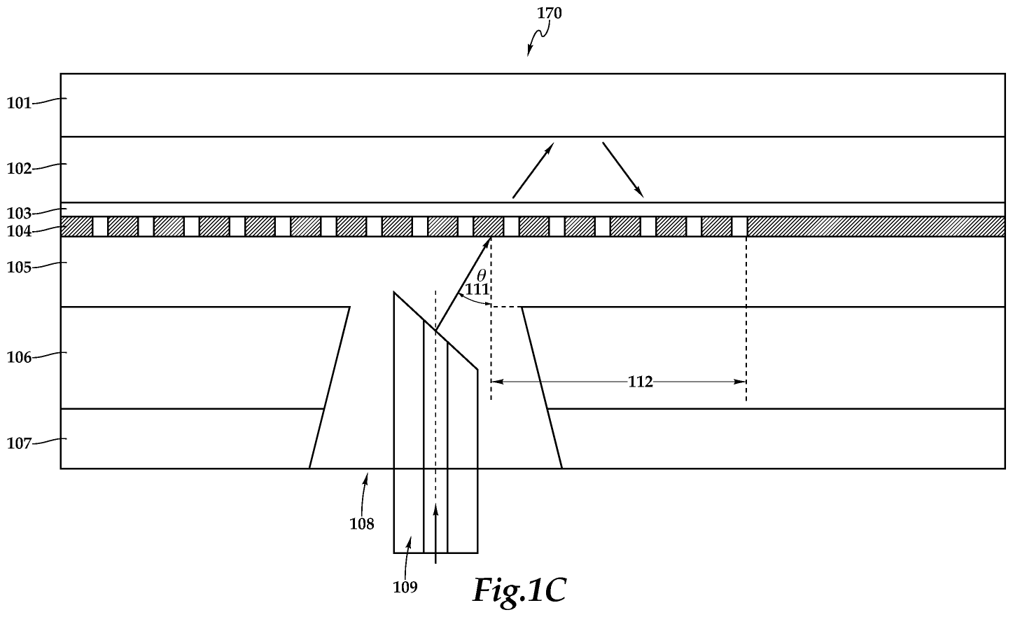

In some embodiments, a step-by-step bottom-up approach may be used to fabricate the BOC. A fiber groove in the backside of the wafer may be designed such that light from the doped silica fiber encounters a low-to-high refractive index interface as it enters the silicon substrate. The light may propagate unattenuated through the substrate media (which may be transparent to infrared or another frequency range corresponding to an optical signal) and may encounter a second interface through the BOX (buried-oxide) layer before it becomes incidence on the grating coupler. The angle and fractional amplitude of light incident on the grating may depend on the interface transfer-matrix. The Fresnel reflection and transmission coefficients from different interfaces may be combined to form a scattering parameter (e.g., S-parameter) matrix for the system. A representational schematic of an exemplary backside optical coupler is shown in FIG. 1A.

Backside optical couplers and techniques for fabrication and operation thereof may be further explicated by reference to “Backside Optical Coupler: A Novel I/O for Mechanically Stable High Efficiency Fiber Coupling” by S. Sunder, A. Jaiswal, and A. Jacob, 2023 IEEE 73rd Electronic Components and Technology Conference (ECTC), Orlando, FL, USA, 2023, pp. 727-731, doi: 10.1109/ECTC51909.2023.00126, the entire contents of which is hereby incorporated by reference in its entirety.

FIG. 1A is a schematic representation of a cross-sectional view of an exemplary backside optical coupler (BOC) 100 in relationship to a waveguide 113 and an optical fiber 109. The BOC 100 consists of the optical fiber 109 in a frustrum 108. The optical fiber 109 has end terminated with an angled polished end at an angle θ 110 of 12.5° (e.g., a fiber polish angle). The frustrum 108 is teched into the backside of a silicon substrate 106. The substrate may be approximately 700 nm thick. The frustrum 108 may be filled, such as with a silicon, silicon dioxide, polymer, etc. The substrate 106 may have a backside reflective coating 107, which may be a DBR mirror, such as consisting of alternating layers of SiO₂ and Si₃N₄. On top of the substrate 106 may be a BOX (e.g., backside oxide) layer 105. The BOX layer 105 (or other separation layer) may have a thickness of approximately 2 μm. On top of the BOX layer 105, a grating 104 may be formed. The grating 104 may have a periodicity (e.g., wavelength A) of approximately 740 nm. The grating 104 may connect to waveguide 113, which may be a rib waveguide and may be fabricated in the same layer as the grating 104. The optical fiber 109 may be separated laterally from the waveguide 113 by a distance x 112. The grating 104 and waveguide 113 may be composed of silicon and may be 220 nm thick. The light emitted from the optical fiber 109 may reach the grating 104 with an incident angle θ 111, measured perpendicular to the grating 104. Alternatively, light may be emitted from the grating with the incident angle θ 111 towards the optical fiber 109. On top of the grating 104 and waveguide 113, a silicon nitride coating layer 103 may be placed. The coating layer 103 may be 350 nm thick. A TOX (e.g., top oxide) layer 102 may be fabricated on top of the grating 104 and waveguide 113 and any coating layer 103. The TOX layer 102 may be 1 μm thick. The assembly may be topped with an additional topside reflective coating 101, such as a DBR mirror, such as consisting of alternating layers of SiO₂ and Si₃N₄. The topside reflective coating 101 and the backside reflective coating 107 may be substantially similar materials, such as DBR mirrors with total reflectance equal to approximately 98.7%.

### Optical Return Loss

Owing to the refractive index contrast between the silicon bus waveguide and the grating, part of the input light from the waveguide may be reflected back into the waveguide instead of transmitting to the grating (or vice versa). The ratio between reflected power and input power from the waveguide is called back reflection to the waveguide, or optical return loss. As shown in FIG. 1B, the angled fiber polish must be less than ˜40° for minimum loss at the first interface and the angle of incidence at the second interface must further remain lesser than ˜15° for optimal reflectivity.

FIG. 1B is a graph 150 depicting Fresnel reflectance and transmittance values along y axis 152 at interfaces between silicon and silicon dioxide as a function of incident angle along axis 151. FIG. 1B depicts reflectance for light moving from SiO₂ to Si as dashed line 160, transmittance for light moving from SiO₂ to Si as dashed line 161, transmittance for light moving from Si to SiO₂ as dashed and dotted line 162, and reflectance for light moving from Si to SiO₂ as solid line 163. Reflectance at the Si to SiO₂ interface substantially increases near 20° while reflectance at the SiO₂ to Si interface substantially increases near 50°, which lead to selection of the angles listed in the preceding paragraph. FIG. 1B also shows that such a high refractive index (e.g., in silicon and silicon dioxide) may automatically cause a loss of about −7.5 dB at an interface. An AR coating at the interface may be used to actively reduce this loss. If a V-groove angled at 45° is considered, it can be seen that the angle of incidence at the second interface may cause total internal reflection (TIR). In some embodiments, for this reason a frustum may be used for housing the fibers. In some embodiments, the index contrast between the substrate and waveguide may be avoided entirely by index matching between the BOX layer and the fiber to minimize minimizing. If the buried oxide has the refractive index of pure silica and the optical fiber is considered to be a Ge-doped SMF-28 core, then the return loss may be as low as −43.5 dB, and may be computed using Equation 1, below, where θᵢ is the angle of incidence, n₁ and n₂ represent the indices of the two media, Rₛ and Rₚ are the reflectance values for the orthogonal polarization states and may be further used to compute transmittance.

$${R}_{s} = \vert \frac{{n}_{1} cos {θ}_{i} - {n}_{2} \sqrt{1 - {( \frac{{n}_{1}}{{n}_{2}} sin {θ}_{i} )}^{2}}}{{n}_{1} cos {θ}_{i} + {n}_{2} \sqrt{1 - {( \frac{{n}_{1}}{{n}_{2}} sin {θ}_{i} )}^{2}}} \vert ; \qquad ( 1 )$$

$${R}_{p} = \vert \frac{{n}_{I} \sqrt{1 - {( \frac{{n}_{1}}{{n}_{2}} sin {θ}_{i} )}^{2}} - {n}_{2} cos {θ}_{i}}{{n}_{1} \sqrt{1 - {( \frac{{n}_{1}}{{n}_{2}} sin {θ}_{i} )}^{2}} + {n}_{2} cos {θ}_{i}} \vert$$

### Grating Optimization

The light may then be incident on a ridge silicon grating coupler. The position, the angle of incidence and the pitch of this grating may be optimized by the “Particle Swarm Algorithm”, a multivariable nonlinear global optimization technique. The grating may be a focusing grating or a parallel grating. Some of the results reported in the next paragraphs may be for a parallel grating. While the grating may be optimized to couple light into the silicon waveguide, it may also scatter light into its transmission orders at angles computed by Equation 2, below:

$${n}_{t} sin {θ}_{m} = {n}_{i} sin θ + m \frac{λ}{Λ} \qquad ( 2 )$$

where nₜ is the index of refraction in the transmitted medium, θₘ is the angle of diffraction, nᵢ is the index of refraction in the incident medium, θ is the angle of incidence, m is the order of the diffraction, λ is the wavelength of light, and Λ is the grating period.

For the embodiment depicted in FIG. 1Ihe optimized grating parameters were found to be Λ=0.74 μm and θ=12.5°. While 53.7% of the light at 1550 nm was coupled into the silicon waveguide, the remainder was incident on Distributed Bragg Reflector mirror optimized for the transmission order. A 350 nm layer of Si₃N₄ was seen to smoothen the index contrast and improve the coupling efficiency by over 6%.

### Distributed Bragg Reflector Mirror

The working of a DBR mirror was modeled using the Redheffer Star product approach of modeling the response of a multilayer device to a single scattering matrix. The algorithm uses a two-stage process of a forward pass, followed by a backward pass wherein for each layer, the mode coefficients for forward cᵢ⁺ and backward cᵢ⁻ direction, and the electric Wᵢ and magnetic Vᵢ fields are computed in an iterative process to obtain the wavefunction given by Equation 3, below:

$${Ψ}_{i ( {z}_{i} )} = [ \begin{matrix}{W}_{i} & {W}_{i} \\ {V}_{i} & - {V}_{i}\end{matrix} ] [ \begin{matrix}{e}^{{λ}_{i} {z}_{i}} & 0 \\ 0 & {e}^{- {λ}_{i} {z}_{i}}\end{matrix} ] [ \begin{matrix}{c}_{i}^{+} \\ {c}_{i}^{-}\end{matrix} ] \qquad ( 3 )$$

where Ψ_{i(z}_{ᵢ}₎ is the wavefunction describing the electromagnetic field at the position zᵢ, and λᵢ are the propagation constants corresponding to the electric fields Wᵢ. The term e^{-λ}^{ᵢ}^{z}^{ᵢ} corresponds to the forward propagation, while e^{λ}^{ᵢ}^{z}^{ᵢ} describe the backward propagation.

Using the pattern search algorithm, the optimal thicknesses of silica and silicon nitride for the embodiment depicted in FIG. 1A corresponding to maximal reflectivity were computed. It was found that 10 layers of 513 nm silica paired with 369 nm of Si₃N₄ may give a combined reflectance of 98.7% to unpolarized light. The specular reflection may cause a recouping of light to the grating, where the angle of incidence of light on the grating may be slightly different from the optimal angle designed earlier, reducing the coupling efficiency to 48.6%.

### Performance Characteristics

Table 1, below, depicts various performance metrics for the embodiment depicted in FIG. 1A.

TABLE 1
Modeled Performance Metrics Corresponding to FIG. 1A

| Insertion Loss | Insertion Loss | | Polarization |
|---|---|---|---|
| (TE) | (TM) | Optical Return Loss | Dependent Loss |
| $10 {log}_{10} \frac{{P}_{wg}}{{P}_{fiber}}$ | $10 {log}_{10} \frac{{P}_{wg}}{{P}_{fiber}}$ | $10 {log}_{10} \frac{{P}_{back - fiber}}{{P}_{fiber}}$ | $10 {log}_{10} \frac{{P}_{TM}}{{P}_{TE}}$ |
| −1.15 dB | −1.94 dB | −43.5 dB | −0.8 dB |

For the embodiment depicted in FIG. 1A, the design parameters for transverse electrical (TE) polarization at 1550 nm may be optimized, as described here. The efficiency may drop by about 12.5% for transverse magnet (TM) polarization. While the fiber is a scalar device, SOI has a high contrast, thus making it highly polarization sensitive. Thus, optimized parameters for a certain polarization may not satisfy an alternate (e.g., orthogonal) polarization. In some embodiments, this may be resolved by design improvements. A device corresponding to the embodiment depicted in FIG. 1A displays a robust wavelength response with a wavelength-dependent loss of less than −1 dB over the C-Band (e.g., 4.0 to 8.0 GHz).

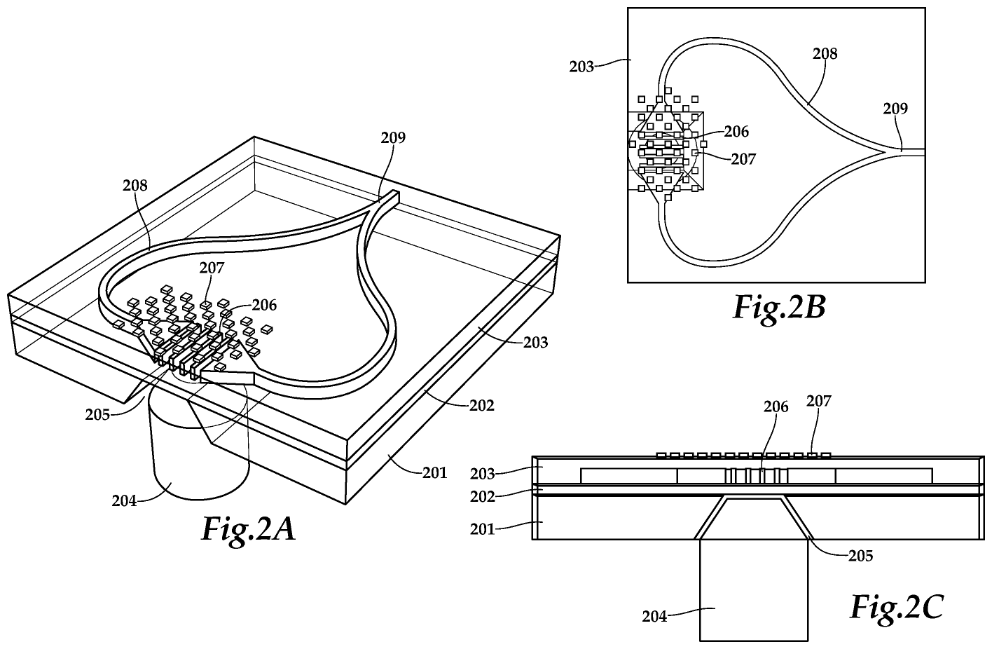

FIGS. 2-7 depict various views of additional embodiments of BOCs, depicting additional or alternative structures which may be present in one or more embodiments of the BOC and which may additionally be combined or rearranged with each other or with the BOC depicted in FIG. 1A.

FIG. 1C is a is a schematic representation of a cross-sectional view of an exemplary backside optical coupler (BOC) 170 in relationship to a waveguide113 and an optical fiber 109 with silica fill. FIG. 1C is depicted using the reference characters previously used for FIG. 1A where elements remain the same. In the BOC 170, the fill of the frustrum 108 and the BOX layer 105 are continuous, including embodiments where the fill of the frustrum 108 may be index matched to the silica of the BOX layer 105.

FIGS. 2A-2C depict various views of a BOC with metamaterial structures and a power combiner. FIG. 2A depicts a perspective view of the BOC, while FIG. 2B depicts a plane view of the topside of the BOC and FIG. 2C depicts a cross-sectional view of the BOC. The BOC of FIGS. 2A-2C contains a substrate 201, a bottom cladding layer 202, a top cladding layer 203, an optical fiber 204, an underfilled V-groove 205, a parallel grating coupler 206, metamaterial structures 207 (e.g., as an antireflection layer), a waveguide 208, and a power coupler/splitter 209. The metamaterial structures 207 may be quantum dots or other analogous dispersed or arrayed elements. The power coupler/splitter 209 may function in different modes based on the I/O mode of the BOC. The optical fiber 204 may be oriented substantially perpendicular to the plane of the substrate 201 and substantially perpendicular to the periodic elements of the parallel grating coupler 206.

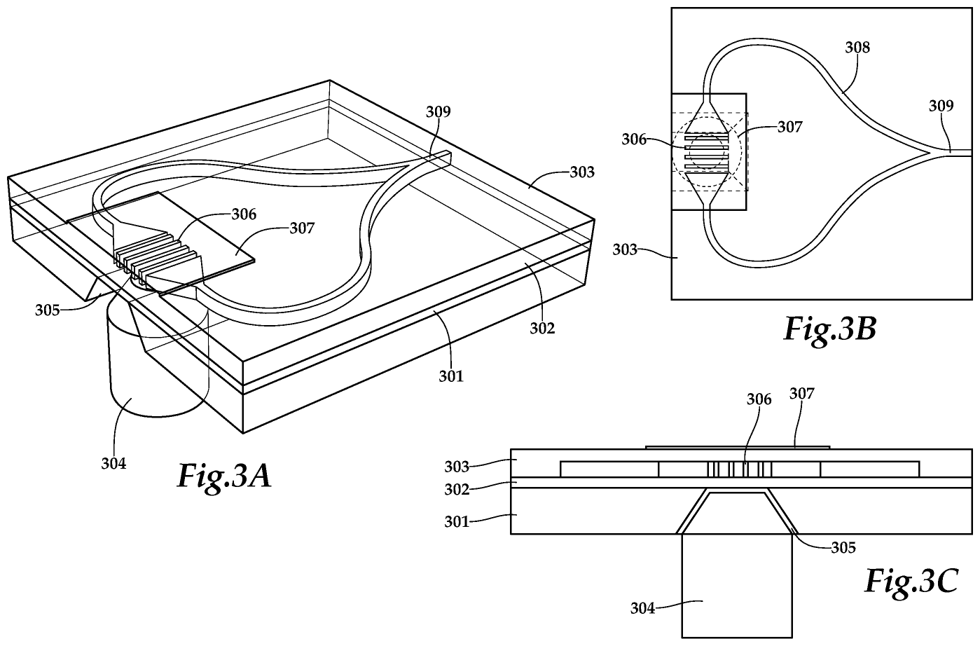

FIGS. 3A-3C depict various views of a BOC with an antireflection coating and a power combiner. FIG. 3A depicts a perspective view of the BOC, while FIG. 3B depicts a plane view of the topside of the BOC and FIG. 3C depicts a cross-sectional view of the BOC. The BOC of FIGS. 3A-3C contains a substrate 301, a bottom cladding layer 302, a top cladding layer 303, an optical fiber 304, an underfilled V-groove 305, a parallel grating coupler 306, a metamaterial structure or coating 307 (e.g., as an antireflection layer), a waveguide 308, and a power coupler/splitter 309. The metamaterial structure or coating 307 may be a substantially contiguous layer. The power coupler/splitter 309 may function in different modes based on the I/O mode of the BOC. The optical fiber 304 may be oriented substantially perpendicular to the plane of the substrate 301 and substantially perpendicular to the periodic elements of the parallel grating coupler 306.

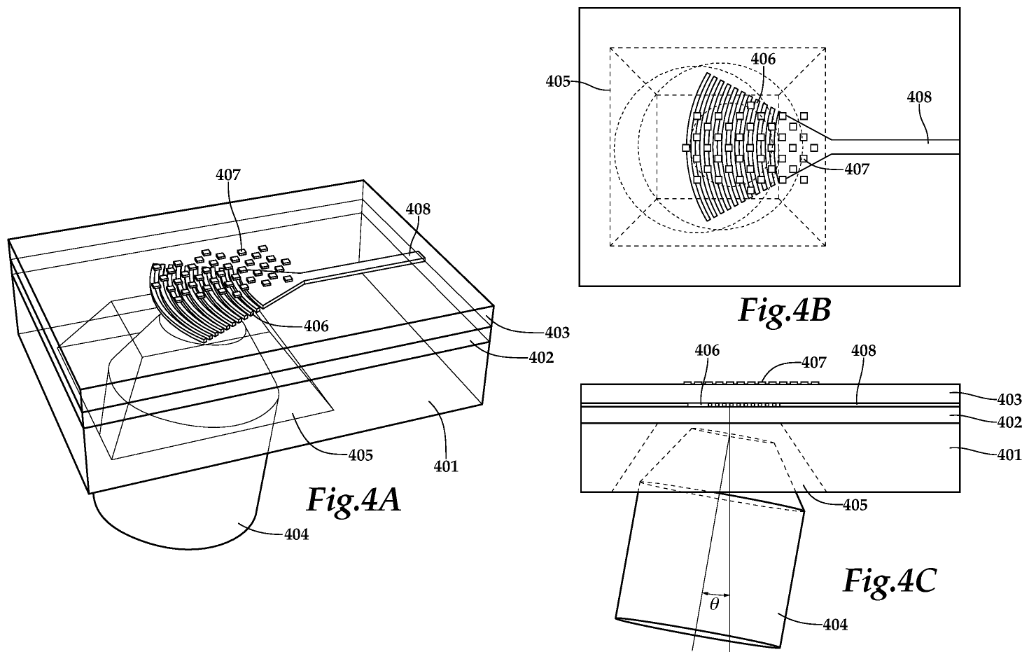

FIGS. 4A-4C depict various views of a BOC with a focusing grating coupler and metamaterial structures. FIG. 4A depicts a perspective view of the BOC, while FIG. 4B depicts a plane view of the topside of the BOC and FIG. 4C depicts a cross-sectional view of the BOC. The BOC of FIGS. 4A-4C contains a substrate 401, a bottom cladding layer 402, a top cladding layer 403, an optical fiber 404, an underfilled V-groove 405, a focusing grating coupler 406, metamaterial structures 407 (e.g., as an antireflection layer), and a waveguide 408. The metamaterial structures 407 may be quantum dots or other analogous dispersed or arrayed elements. The optical fiber 404 may be oriented at an angle θ to the plane of the substrate and the plane of the focusing grating coupler 406.

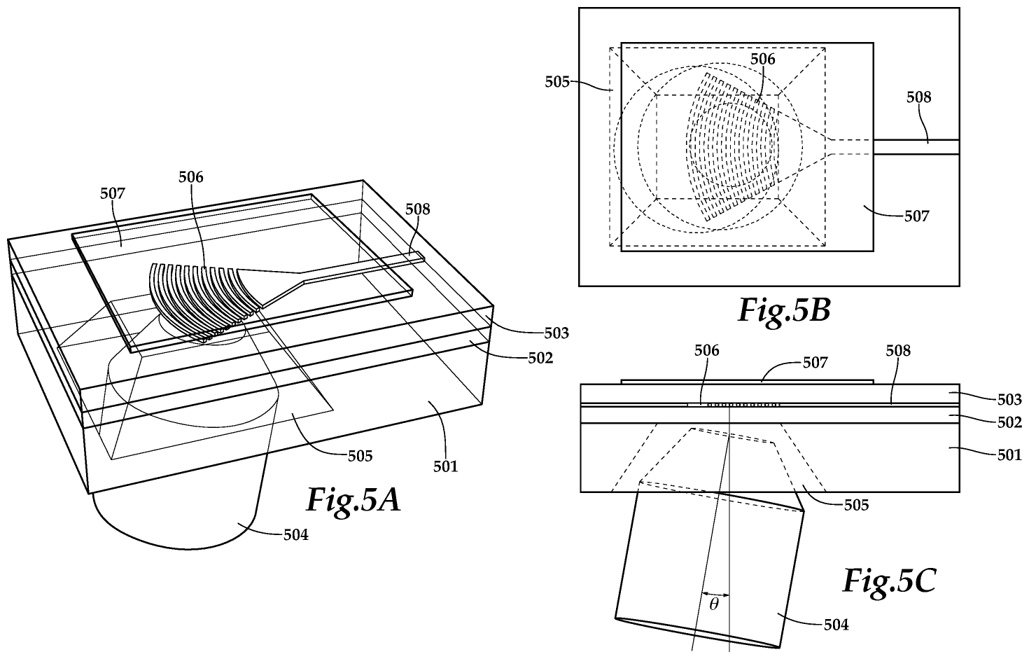

FIGS. 5A-5C depict various views of a BOC with a focusing grating coupler and an antireflection coating. FIG. 5A depicts a perspective view of the BOC, while FIG. 5B depicts a plane view of the topside of the BOC and FIG. 5C depicts a cross-sectional view of the BOC. The BOC of FIGS. 5A-5C contains a substrate 501, a bottom cladding layer 502, a top cladding layer 503, an optical fiber 504, an underfilled V-groove 505, a focusing grating coupler 506, an antireflection coating 507, and a waveguide 508. The antireflection coating 507 may be over an area corresponding to the area of the V-groove 505, the focusing grating coupler 506, substantially the whole substrate 501, etc. The optical fiber 504 may be oriented at an angle θ to the plane of the substrate and the plane of the focusing grating coupler 506.

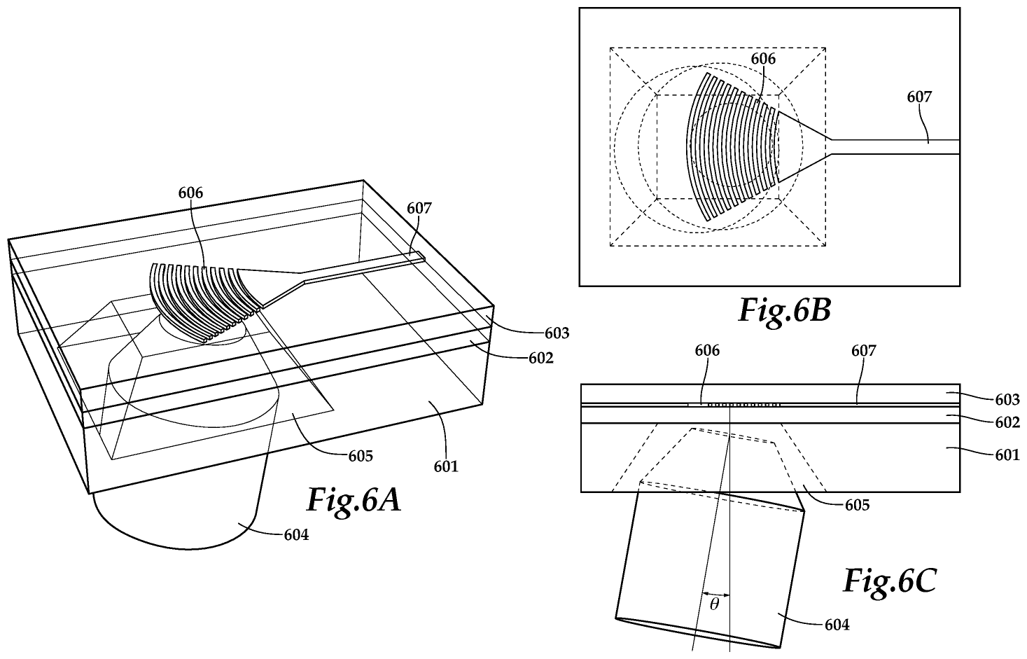

FIGS. 6A-6C depict various views of a BOC with a focusing grating coupler. FIG. 6A depicts a perspective view of the BOC, while FIG. 6B depicts a plane view of the topside of the BOC and FIG. 6C depicts a cross-sectional view of the BOC. The BOC of FIGS. 6A-6C contains a substrate 601, a bottom cladding layer 602, a top cladding layer 603, an optical fiber 604, an underfilled V-groove 605, a focusing (e.g., curved) grating coupler 606, and a waveguide 607. The optical fiber 604 may be oriented at an angle θ to the plane of the substrate and the plane of the focusing grating coupler 606.

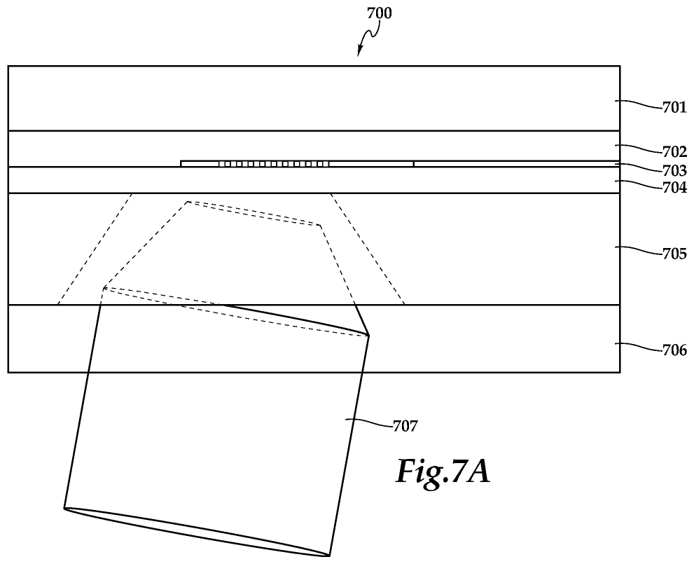

FIGS. 7A-7B depict various views of BOCs with a focusing grating coupler and multiple reflective coatings, in accordance with one or more embodiments. FIG. 7A depicts a cross-sectional view of the BOC 700. The BOC 700 contains a top reflective coating 701, a TOX layer 702, a grating layer 703, a BOX layer 704, a silicon substrate 705, a bottom reflective coating 706, and an optical fiber 707. The grating layer 703 may contain a focusing grating coupler and a waveguide, such as previously depicted in FIGS. 4C, 5C, and 6C.

FIG. 7B depicts a perspective view of FIG. 7A depicts a cross-sectional view of the BOC 750. The BOC 750 contains a DBR mirror 751, a TOX layer 752, a Si waveguide 753, a Si₃N₄ layer 754, a BOX layer 755, a focusing grating 756, a substrate 757, a V-groove 758, a DBR mirror 759 (e.g., backside reflector), and an optical fiber 760.

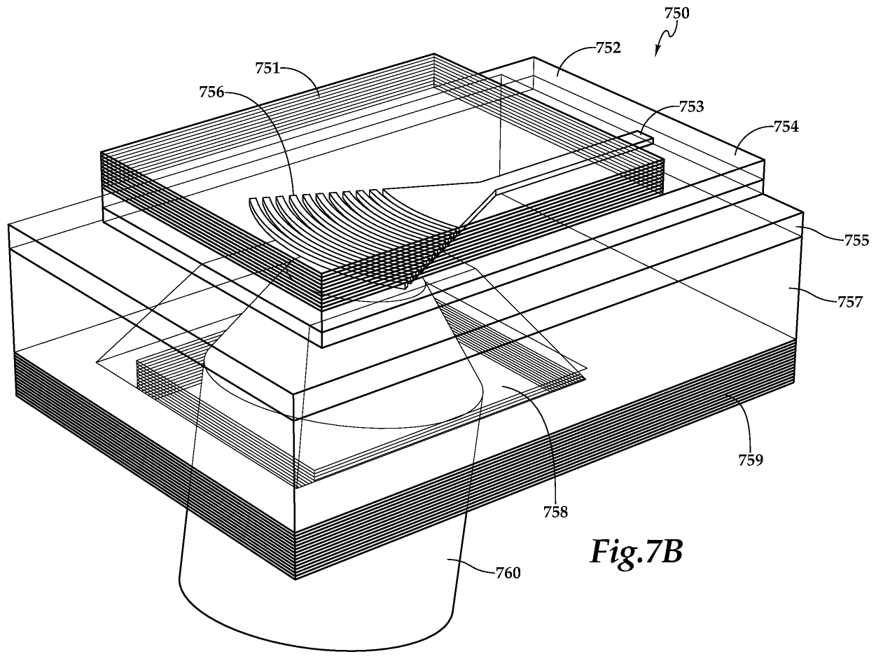

FIG. 8 depicts a cross-sectional view of a graded index V-groove fill 800 for fiber integrations in a BOC. One or more optical fibers, such as single mode fibers (SMF), multi-mode fibers, etc., may be integrated into the BOC, including by integration of a fiber optic cable or set of optical fibers. A set of N optical fibers, including SMF 801a thought SMF 801n, is depicted with a width w₁ 802 substantially equal to n times m time r, where N is substantially equal to m by n for a m by n array of fibers and r is substantially equal to the radius of the SMF. The set of N optical fibers may terminate into an adiabatic multi-fiber taper, such as used for high fiber density. The adiabatic taper may have height 803 and terminal width w₂ 804, where w₂ may be less than w₁ (the width of the set of N optical fibers). The adiabatic taper may have any appropriate taper profile, such as linear, adiabatic, etc. The adiabatic taper may terminate into graded index—doped silica, such as graded index-doped silica filling a V-groove or other substrate penetration area. The graded index-doped silica may be index matched to the substrate, to a BOX layer, to a TOX layer, etc., such as to provide efficient light coupling into and out of a waveguide and grating and out of and into an optical fiber. The graded index-doped silica may have a height 805 and a terminal width, such as at the substrate interface, of w₃ 806, which may be less than w₂ 804, the terminal width of the adiabatic taper. The height 803 of the adiabatic taper and the height 805 of the graded index-doped silica may be selected based on a coherence length of the light, based on the substrate and V-groove size, based on a taper profile and width, etc.

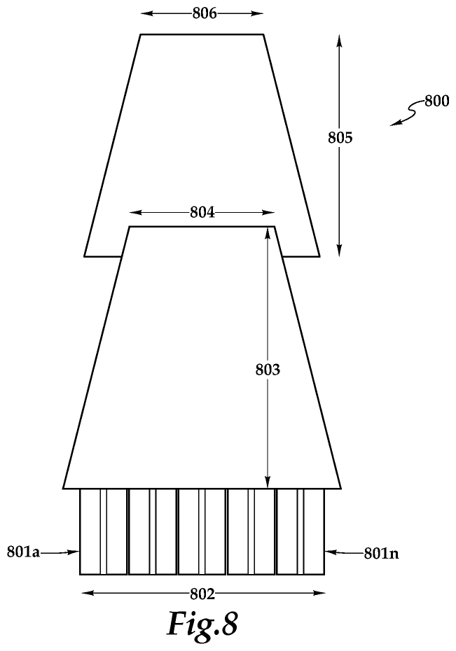

FIG. 9 depicts a PIC 904 with fiber pig tails 905 attached by BOCs integrated into a package 900. FIG. 9 is a cross-sectional view of the PIC 904 in package 900. The PIC 904 may be included in a package for integration into a computing device. The PIC 904 may be etched with grooves (such as V-grooves) for integration with optical fiber pig tails 905. The PIC 904 may be integrated with one or more heat sink 901 and a heat spreader 902 for heat dissipation. The PIC 904 may be bonded, such as by one or more solder pump 906, to a packaging substrate 908 with one or more redistribution layers (RDL) 909a, 909b. The RDLs 909a, 909b may include communication layers or one or more communication layer may be included elsewhere in the packaging substrate 908. The packaging substrate 908 may be connected to other devices, such as by solder balls 910 or other interconnects. The PIC 904 may be connected, such as by the fiber pig tails 905, to one of more optical sources, such as a laser 911. In some embodiments, an optical source (such as a laser) may be homogeneously integrated into the PIC 904, such as in the form of a photodiode. Integration of the laser 911 or another optical source may be heterogeneous, including at a packaging level, such as through the packaging substrate 908, one or more solder balls 910, though optical fibers (such as via fiber pig tails 905), etc. The PIC 904 and the heat spreaders 902 and heat sink 901 may be thermally connected, such as by a fill layer 903. The PIC 904 may also have electrical connections, sensor connections, optical connections, etc. on a topside, such as between the PIC 904 and the heat spreaders 902, although these are not depicted in FIG. 9 for visual clarity reasons.

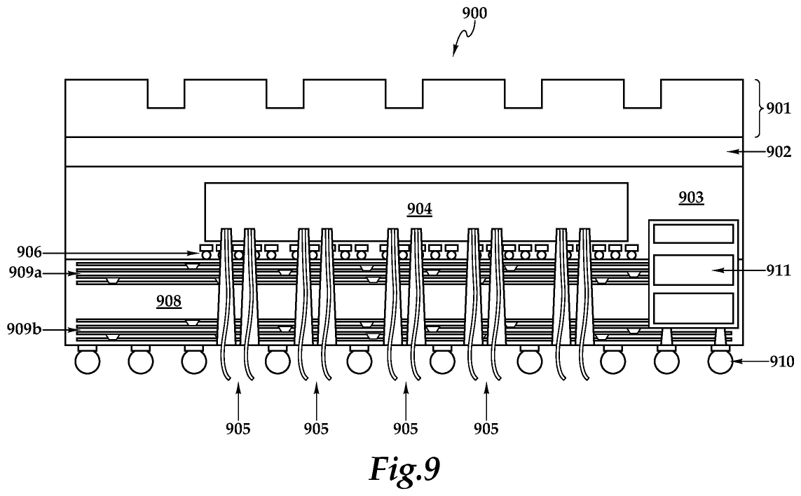

FIG. 10 depicts a co-packaging structure 1000 for a BOC with fiber pig tails 1001 attached to a packaged PIC 1013. FIG. 10 is a cross-sectional view of the PIC 1013 in the co-packaging structure 1000. The PIC 1013 is depicted as flip-chip bonded to an interposer 1009. The PIC 1013 contains optical I/O through optical fibers pig tails 1001 connected to BOCs 1002 in V-grooves 1003. The backside of the PIC 1013 is depicted as the topside in the co-packaging structure 1000, with the topside (from a fabrication perspective) bonded to the interposer 1009 though copper bumps 1007 connected to a RDL and communication layer 1004. The interposer 1009 contains through silicon vias (TSVs) 1008 enabling electrical connections between the PIC 1013 and a packaging substrate 1015, such as by connection though ultra bump metallization 1010 and solder bumps 1011. The packaging substrate 1015 may also contain one or more RDL and communication layer 1016a and 1016b, which may include buildup layers. The packaging substrate 1015 may be connected to one or more additional substrate or chip, such as through solder balls 1012. The PIC 1013 may contain an embedded optical source, such as an embedded laser source, which may be integrated though back-end-of-line (BOEL) processing. The PIC 1013 may be electrically connected, such as through the interposer 1009 with other circuits, such as an application-specific integrated circuit (ASIC) 1014, memory 1006, one or more processor (not depicted), etc. The fiber pig tails 1001 may be in optical communication with one or more optical device, including optical transducers, microwave frequency optical devices, optical detectors, optical sources, etc.

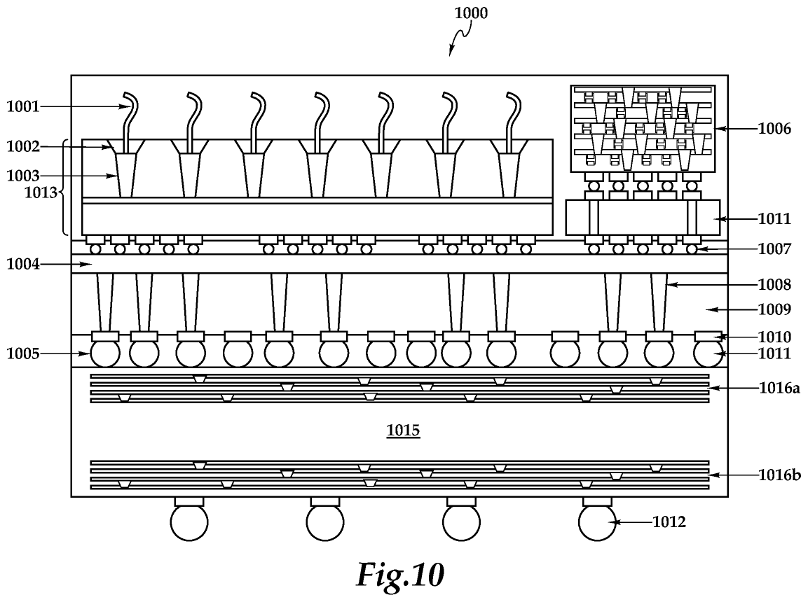

FIG. 11 depicts a relationship between the co-packaged optics of FIG. 10 and the exemplary BOC of FIG. 1A. In some embodiments, a BOC may be integrated, such as heterogeneously, in a package containing PIC and electrically based integrated circuits. Although the exemplary BOC of FIG. 1A is depicted, a BOC of any other embodiment may be analogously packaged, including with laser source, light source, memory, processors, sensors, one or more circuit array, etc.

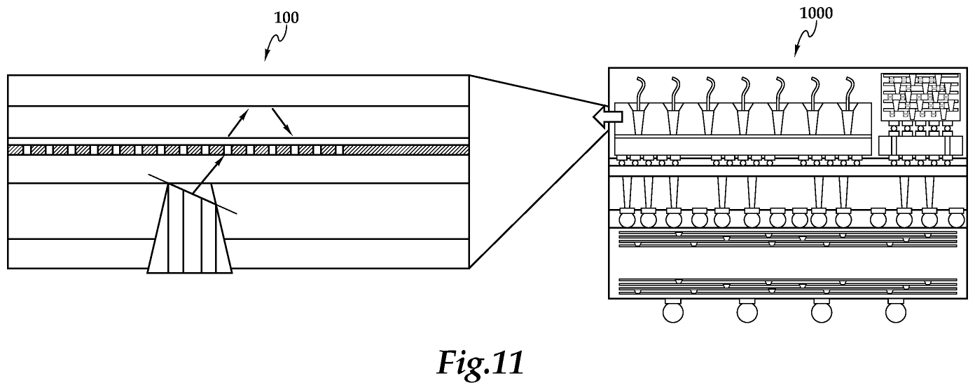

FIG. 12 depicts a schematic representation 1200 of optical signal transmission through a BOC 1210. The BOC 1210 may receive one or more optical signals from an optical fiber 1222. The optical fiber may be a SMF, a multi-mode fiber, etc. The optical signal may be a coherent signal. The optical signal may have multiple wavelengths, a range of wavelengths, etc. The optical signal may be a multiplexed signal. The optical signal may be generated by an optical source 1220, which may be one or more lasers, one or more diodes, etc., including a set of multiple optical sources. The optical source 1220 may be in optical communication with the optical fiber 1222, including integrated with the optical fiber 1222, spliced with the optical fiber 1222, etc. The backside optical coupler 1210 may receive the optical signal from the optical fiber 1222. The backside optical coupler 1210 may transmit the optical signal to a waveguide 1234, where the waveguide 1234 may be integrated into a photonic integrated circuit 1230. Alternatively or additionally, the backside optical coupler 1210 may receive an optical signal from the waveguide 1234, which may be integrated into the photonic integrated circuit 1230. The backside optical coupler 1210 may be substantially symmetrical to transmitting and receiving (e.g., from either the optical fiber 1222 or the waveguide 1234) or may be optimized for transmission in one direction (e.g., from the optical fiber 1222 to the waveguide 1234 or from the waveguide 1234 to the optical fiber 1222). The backside optical coupler 1210 may transmit a signal to the optical fiber 1222, which may then be detected or received by another device, such as by an optical detector 1240.

### Backside Optical Coupler for Quantum Computing

For a fault-tolerant quantum computer architecture, integrating several qubits with optimized signal routing and control electronics, without sacrificing the quantum coherence may be sought. Monolithic integration of such devices may be challenging due to the material and thermodynamic incompatibilities of different quantum components and their parasitic modes, which may increase with spatial proximity. In some embodiments, a heterogeneously-integrated scalable interposer packaging architecture may be used to merge and interconnect different functionalities within a sophisticated chip while maintaining qubit coherence. Different types of qubits may be integrated using different types of interposer level packaging of, such as superconducting qubits, using an electrical interposer and ion trap qubits, using an optical interposer. In some embodiments, a Quantum Chip optoelectronics Interposer Packaging (QuIP) with heterogeneously integrated electrical and optical quantum components, interconnected using electrical (e.g., superconducting microstrip), electromagnetic (e.g., inductive or capacitive), and integrated optical interconnects is presented.

In some embodiments, silicon may be chosen as the interposer material, which may be a relatively compatible platform for qubit integration, microwave electronics, and photonics. In order to minimize the electromagnetic interference, the qubit chips may be separately fabricated and flip-chip bonded to the interposer using niobium (Nb) or indium (In) bonds and electrically connected to the bottom superconducting redistribution layer via through-silicon-via (TSV). The qubit information in the microwave frequency domain may be converted to the optical frequency domain using an electro-optic quantum transducer based on an AlN-on-Sapphire platform. Signals in the optical frequency domain may be transmitted between chips by optical fibers, such as by use of a BOC as previously described to couple waveguides and optical fibers. The qubit chip and transducer chip may be coupled inductively (which may be relatively alignment tolerant), such as if the qubit sources are relatively well-isolated from any thermal and optical leakage from the transducer chip. The interposer chip may also be integrated with chiral topological material-based microwave circulators, which may be up to 1000 times smaller than conventional off-chip 3D cavity circulators. Such directional interconnects may be desired in a fault tolerant machine to increase the coherence time and reduce the error rate below the threshold value for quantum error correction. In addition to that, quantum memory, quantum sensors, and other types of qubit sources (photonic, ion trap) may also be integrated heterogeneously on the same interposer.

The interposer may also have an optical fiber interface (V-grooves, grating couplers, etc.) to establish chip-to-chip communication, such as optical communication via optical fibers, within/between dewars, dilution refrigerators, and cryogenic chip-to-outside world interconnections. The cryogenic electronic control circuits may also be attached to the BEOL, such as of a photonic or quantum chip, and connected through TSV or flip-chip bonding to improve the heat load dissipation further and, therefore, improve noise and coherence. In some embodiments, the quantum chip interposer packaging may be a scalable and manufacturable solution that may improve the size, speed, power, mechanical and thermal robustness for quantum computing.

### Fabrication of Backside Optical Coupler

In some embodiments, a backside optical coupler may be fabricated on a silicon or silicon on insulator (SOI) substrate. Well-characterized silicon processing techniques may be used, including in unconventional ways. In some embodiments, 220 nm of silicon on ˜2 μm silicon dioxide (e.g., as a BOX layer). The thickness and width of the silicon and silicon dioxide may vary based on the process and wavelength of light used in the BOC. For example, 500 nm silicon may be used for 1.5 μm light, while 350 nm silicon may be used for 1.3 μm light.

A grating and waveguide may be patterned into the silicon layer. The patterning may occur using lithography and etch steps, including anisotropic etching. The waveguide may be a rib waveguide, such as with a width of 500 nm and a thickness of the silicon layer (for example, 220 nm). The grating and waveguide may be passivated by one or more surface layers or fill. Other photonic elements, such as resonators, inductors, bus waveguides, etc. may be patterned into or onto the silicon layer, such as during the patterning of the grating and waveguide.

A silicon dioxide layer (e.g., a fill or cladding layer) may be deposited onto the patterned silicon layer (and within gaps in the silicon layer). The silicon dioxide layer may be polished to the same thickness of the silicon (e.g., 220 nm). The silicon dioxide layer may form part of the grating, together with periodic structures in the silicon layer.

A thin film may be deposited on the silicon/silicon dioxide layer (e.g., containing the grating and waveguide), such as a silicon nitride (SiN) or poly-crystalline silicon. The thin film may be polished to a substantially uniform thickness, such as to approximately 350 nm.

A silicon dioxide layer (e.g., a TOX layer) may be deposited on the thin film, such as with a thickness of ˜1 μm and polished. A reflector, such as a DBR mirror of alternating layers of SiO₂ and SiN, may be deposited on top of the silicon dioxide layer. The DBR may have thickness of roughly 370 nm in SiN layers and 500 nm in SiO₂ layers. An organic layer, such as a polymer layer, may be deposited on the reflector, such as to protect the reflector and other layers.

The wafer may then be flipped for backside processing. A reflector, such as a DBR, which may be substantially identical to the DBR deposited on the topside, may be deposited on the backside of the wafer, along with any desired polishing or planarization. Regions of the DBR may be patterned, such as by lithography and etching, as well as V-grooves (or other contact regions) etched into the backside of the wafer. An organic or silicon dioxide layer may be deposited on the backside of the wafer, including within the V-groove, for passivation or to provide for index matched doping between an optical fiber and the bulk of the wafer.

One a PIC is fabricated (or during fabrication), it may have BOCs created. Copper bumps may be fabricated to provide electrical contact to elements of the PIC. An interposer may be fabricated, with or without TSV, RDL layers, communication layers, copper bumps, etc. The interposer may be designed to complement the optical fibers and copper bumps of the PIC, in order to make packaging easier. The PIC may be flip chip bonded onto the interposer, such as with the optical fibers facing away from the interposer (or alternatively or additionally with the optical fibers threaded through the interposer). An ASIC or other chip, such as a memory chip, may also be flip chip bonded onto the interposer, including bonded onto a different side or area of the interposer than the PIC. The interposer may then be bonded to a substrate, which may be an organic substrate. The optical fibers may then be inserted into the BOCs. Optical fibers, such as pig tail optical fibers, optical fibers with adiabatic tapers, etc., may be inserted into the BOCs, such as into V-grooves, into frustrums, though mechanical housings, etc.

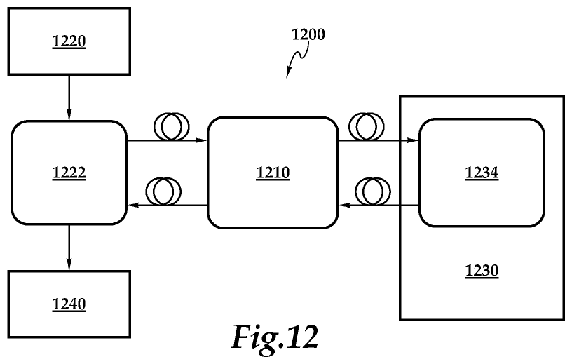

FIG. 13 is a system diagram that illustrates an example optical computing system using a BOC. Various portions of systems and methods described herein may include or be executed on one or more computing systems similar to computing system 1300. Further, processes and modules described herein may be executed by one or more processing systems similar to that of computing system 1300.

Computing system 1300 may include one or more processors (e.g., processors 1320a-1320n) coupled to system memory 1330, and an I/O device interface 1340 via an optical input/output (I/O) interface 1350. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1300. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may operate based on electrical signals (e.g., by analog or digital signal processing) or may operate based on optical signals (e.g., by optical signal processing). A processor may receive instructions and data from a memory (e.g., system memory 1330). Computing system 1300 may be a uni-processor system including one processor (e.g., processor 1320a-1320n), or a multi-processor system including any number of suitable processors (e.g., 1320a-1320n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1300 may include a plurality of computing devices (e.g., distributed computing systems) to implement various processing functions.

The I/O device interface 1340 may comprise one or more I/O device interface, for example to provide an interface for connection of one or more I/O devices 1390 to computing system 1300. The I/O device interface 1340 may include devices that receive input (e.g., from a user) or output information (e.g., to a user). The I/O device interface 1340 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. The I/O device interface 1340 may receive signals from one or more I/O device 1390, such as an optical signal generator, an electro-optic transducer, including a microwave transducer, a qubit or other quantum computing element, etc. The I/O device interface 1340 may transmit signals to the one or more I/O device 1390, such as an optical detector, an electro-optic transducer, including a microwave transducer, a qubit or other quantum computing element, etc. The I/O device interface 1340 may be connected to computing system 1300 through a wired or wireless connection. The I/O device interface 1340 may be connected to computing system 1300 from a remote location. The I/O device interface 1340 may be in communication with one or more other computing systems. Other computing units, such as located on remote computer system, for example, may be connected to computing system 1300 via a network 1380, such as via a network interface 1370. The I/O device interface 1340 may be a user interface. The I/O device interface 1340 may connect multiple computer systems.

System memory 1330 may be configured to store program instructions 1332 or data 1334. Program instructions 1332 may be executable by a processor (e.g., one or more of processors 1320a-1320n) to implement one or more embodiments of the present techniques. Program instructions 1332 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1330 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 1330 may include a non-transitory computer readable storage medium that may have program instructions stored thereon that are executable by a computer processor (e.g., one or more of processors 1320a-1320n) to cause the subject matter and the functional operations described herein. A memory (e.g., system memory 1330) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

Optical I/O interface 1350 may be configured to coordinate I/O traffic between processors 1320a-1320n, system memory 1330, I/O device interface 1340, network interface 1370, etc. Optical I/O interface 1350 may perform protocol, timing, or other data transformations to convert data signals from one component (e.g., system memory 1330) into a format suitable for use by another component (e.g., processors 1320a-1320n). Optical I/O interface 1350 may include support for devices attached through various types of peripheral buses, such as a variant of the Peripheral Component Interconnect (PCI) bus standard or the Universal Serial Bus (USB) standard. Optical I/O interface 1350 may be supplemented by one or more electrical I/O interface, not depicted, including an electrical I/O interface which may connect elements such to coordinate electrical I/O traffic between processors 1320a-1320n, system memory 1330, I/O device interface 1340, network interface 1370, etc. in parallel with the optical I/O traffic.

Optical I/O interface 1350 may contain a backside optical coupler 1354, such configured to transmit optical signals between a waveguide 1352 and an optical fiber 1356. The optical I/O interface 1350 may be connected to one or more of the processors 1320a-1320n, system memory 1330, I/O device interface 1340, network interface 1370, etc., by the waveguide 1352 and the optical fiber 1356. The backside optical coupler 1354 may be any appropriate backside optical coupler, such as previously described.

Embodiments of the techniques described herein may be implemented using a single instance of computing system 1300 or multiple computing systems 1300 configured to host different portions or instances of embodiments. Multiple computing systems 1300 may provide for parallel or sequential processing/execution of one or more portions of the techniques described herein.

Those skilled in the art will appreciate that computing system 1300 is merely illustrative and is not intended to limit the scope of the techniques described herein. Computing system 1300 may include any combination of devices or software that may perform or otherwise provide for the performance of the techniques described herein. For example, computing system 1300 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 1300 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 1300 may be transmitted to computing system 1300 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

### Proof of Concept for Exemplary BOC

In some embodiments, a BOC for fiber-to-chip coupling using the backside of the wafer is present. In some embodiments, an optical I/O design utilizing this approach may present efficient, reliable, and low-loss light coupling. In some embodiments, the proposed design may consist of a V-groove fiber housing array on the backside of the wafer, which may enable ultra-high density fiber integration with mechanical stability. The backside optical coupler may employ an efficient rib waveguide grating structure for the coupling mechanism while containing the light using an all-dielectric Distributed Bragg Mirror. This may offer the flexibility to implement novel grating coupling schemes to improve the coupling efficiency for different wavelength ranges and suppression of polarization-dependent losses. In some embodiments, the area advantage of the backside optical coupler may be exploited to realize ultra-high channel density optical I/Os. In some embodiments, under the TE-optimized backside optical coupler design, the coupling efficiency may peak at −0.78 dB at 1550 nm with wavelength-dependent loss as low as 0.5 dB over the C-band.

In some embodiments, a Silicon-on-insulator (SOI) platform may be used for monolithic integration of hybrid optical and electrical devices, due to the high-volume manufacturing technologies available in the microelectronics industry for silicon and SOI. While data transmission in the optical domain may be facilitated by doped silica optical fibers, the SOI platform may employ silicon waveguides for light transfer. Optical I/Os may be used to facilitate light coupling between the SOI platform and long-range optical fibers. Optical I/Os may therefore be useful in applications which involve fiber-to-chip coupling, such as biophotonics, optical computing, quantum information and optical communication to name a few. Creation of low-loss optical I/O for photonic integrated circuits (PIC) may be an engineering challenge and may be facilitated by a grating or an edge coupling mechanism. The large refractive index and feature size contrast between the silicon (n=3.47 at 1550 nm) and the silica (n=1.444 at 1550 nm) may translate to an order of magnitude contrast in the mode field diameters between the two media. The cross-sectional area of a typical SMF core may be ˜600 times larger than that of a standard silicon waveguide. Hence, the I/O coupling may require facilitating technologies that may adjust the mode-field diameter accordingly.

In some instances, edge coupling using spot-size converters and lensed fibers may attempt to overcome mode mismatch. For example, an edge coupling with an insertion loss ˜0.5 dB at 1310 nm in the O-Band, between SMF28 and the SiPh IC using an on-die integration with coupling facilitated by an inverse taper optical mode transformer with multiple SiN layers and anti-reflection coating on the spot-size converter faucets has been reported. However, such edge coupling approaches may need efficiently designed spot-size converters, precision alignments and may only be used along the edges of the wafer limiting channel density. The complicated postprocesses and high-resolution optical alignment also increases the packaging cost. None of which is to suggest that any technique suffering to some degree from these issues is disclaimed or that any other subject matter is disclaimed.

In some embodiments, an approach of using grating couplers has several advantages; alignment to grating couplers may be much easier than alignment to edge couplers; the absence of post-processing in the fabrication and the flexibility of positioning may enable wafer-scale automated in-line testing during manufacturing and may the cost of manufacturing low. It should also be noted that grating couplers may simplify the design and implementation as they may avoid the use of spot-size converters. Designs of grating couplers have been demonstrated; however, they may come with a different set of challenges for practical implementation. For example, a grating coupler with a coupling loss less than 1 dB at 1492 nm was reported, where the coupler was built on a double SOI substrate with an additional layer of crystalline silicon and silicon dioxide used between the buried oxide and the silicon handle to form a Bragg reflector mirror. A major drawback in grating couplers may be the polarization dependent loss, however techniques have been presented to tackle the same, like polarization splitting grating couplers, albeit with low coupling efficiency. The main factors inhibiting the efficiency of a conventional grating coupler may be penetration loss, mode mismatch, and back reflection. Penetration loss refers to the ratio of power lost to the substrate to the power coupler into the silicon waveguide. A conventional grating coupler may also lack the physical infrastructure to house optical fibers, thus inversely affecting mechanical stability and angle-sensitive coupling efficiency. Optical testing may rely on polarization control, the health of the fragile fiber probes, as well as stringent positional requirements. The topside coupler may occupy much space, adversely affecting component integration in traditional device packaging. None of which is to suggest that any technique suffering to some degree from these issues is disclaimed or that any other subject matter is disclaimed.

In some embodiments, a fiber-to-chip coupling approach through the backside of the wafer is presented. In some embodiments, an optical I/O design is presented where light from the fiber is coupled to a photonic integrated circuit from the backside of the wafer using a rib waveguide grating coupler. The design may contain mechanically stable V-groove fiber housing with high fan-in capabilities. Further, the design may contain an all-dielectric Bragg mirror on the topside of the PIC, allowing for dense component integration on the top and the edges of the PIC. In some embodiments, a simulated design may be optimized and evaluated to have an insertion loss ˜78 dB with low wavelength dependent loss and competitive fabrication tolerance characteristics. In some embodiments, this approach may be practically realizable while having coupling efficiencies competitive with other technologies. The following section discusses various design aspects relating to a unit cell of an exemplary backside optical coupler (BOC). The analysis traces the optical path from the fiber through different interfaces, the coupling grating structure, the reflection of transmission orders to the silicon waveguide. The next section discusses the designs performance metrics in terms of bandwidth, polarization and fabrication tolerance.

### Design of Backside Optical Coupler

In some embodiments, the design of the backside coupler may follow the optical path from the single-mode fiber to the silicon waveguide. A V-groove housing may contain the optical fibers on the backside of the wafer. Light from the doped silica fiber may encounter a low-to-high refractive index interface as it enters the silicon substrate. It may propagate unattenuated through the substrate media (which may be transparent to infrared) to encounter a second interface through the BOX (buried oxide) layer before it may be incident on the grating coupler. The angle of incidence of light on the grating may be controlled by angled fiber cuts (e.g., of the optical fiber). The Fresnel reflection and transmission coefficients from different interfaces may be combined to form an S-parameter matrix for the system. The S-parameter matrix may describe the relationship between the input and the output of the optical system. The light incident on the grating may be coupled to the different diffraction orders of the grating. The coupling efficiency of interest may be a measure of the fractional power coupled into the silicon waveguide on the grating plane. The light coupled into the transmission orders may then be reflected back onto the grating using a dielectric Bragg mirror. The design optimization problem may be to maximize the objective function (coupling efficiency) under the various design constraints and may be performed using multiple derivative-free global optimization algorithms. Light propagation through the device may be modeled using the finite difference time domain (FDTD) method. The analysis has been elaborated in the following subsections.

### Substrate Layer

Due to the refractive index contrast between the optical fiber and the Silicon substrate, part of the input light from the waveguide may be backreflected into the fiber. The ratio between the reflected power and the input power from the fiber may be described as the optical return loss. This reflection may be modelled using a transfer matrix and the reflection coefficients of the two orthogonal polarization states may be described using Equations 4a and 4b, below:

$${R}_{s} = \vert \frac{{n}_{1} cos {θ}_{i} - {n}_{2} \sqrt{1 - {( \frac{{n}_{1}}{{n}_{2}} sin {θ}_{i} )}^{2}}}{{n}_{1} cos {θ}_{i} + {n}_{2} \sqrt{1 - {( \frac{{n}_{1}}{{n}_{2}} sin {θ}_{i} )}^{2}}} \vert \qquad ( 4 a )$$

$${R}_{p} = \vert \frac{{n}_{L} \sqrt{1 - {( \frac{{n}_{1}}{{n}_{2}} sin {θ}_{i} )}^{2}} - {n}_{2} cos {θ}_{i}}{{n}_{L} \sqrt{1 - {( \frac{{n}_{1}}{{n}_{2}} sin {θ}_{i} )}^{2}} + {n}_{2} cos {θ}_{i}} \vert \qquad ( 4 b )$$

where θᵢ is the angle of incidence, n₁ and n₂ represent the indices of the two media, Rₛ and Rₚ are the reflectance values for the orthogonal polarization states and are further used to compute the transmittance. The reflectance and transmittance as a function of the incident angle are shown in FIG. 1A. As previously described in reference to FIG. 1A, it may be seen that angled fiber cuts may lead to an angle of incidence less than 40° for minimum loss at the first interface and the angle of incidence at the second interface may remain lesser than 15° for optimal transmittance.

As previously described in reference to FIG. 1A, a high index contrast may cause a loss of about −7.5 dB. An anti-reflective (AR) coating at the interface may actively reduce the loss at the cost of design and fabrication process complexity. If a V-groove angled at 45° is considered, it may be seen that the angle of incidence at the second interface may cause total internal reflection. In some embodiments, this may be the reason a frustum may be used for housing the fibers (as depicted in FIG. 1C). Avoiding the index contrast with the substrate entirely and index matching between the BOX layer and the fiber may minimize the fiber return loss. If the buried oxide has the refractive index of pure silica, while the optical fiber is a SMF with a Ge doped fiber core, then the optical return loss may be as low as −43.5 dB.

### Grating Optimization

Next, tracing the optical path in one or more embodiments, the light may be considered to be incident on a ridge silicon grating coupler. The position, the angle of incidence and the pitch of this grating may be optimized by the ‘Particle Swarm Algorithm’, a multivariable nonlinear global optimization technique. The grating, as shown in FIG. 7B, may be a focusing grating. While the grating may be optimized to couple light into the silicon waveguide, it may also scatter light into transmission orders at angles computed by Equation 2. The rib grating may be formed by depositing a layer of Si₃N₄ on the Si/SiO₂ ridge grating structure.

In some embodiments, this grating design may be optimized for TE coupling—while its response for TM coupling may also be computed. The polarization dependence of the composite structure is discussed in the following section. For one or more embodiments, the optimized grating parameters may be found to be pitch Λ=. 81 μm, duty cycle d=0.89 μm, with incident angle θ˜11º. While up to 70.3% of the light at 1550 nm may be coupled into the silicon waveguide, the remainder may be incident on Distributed Bragg Reflector (DBR) mirror optimized for the transmission order. In the ridge structure, silicon nitride may be preferred over polysilicon to achieve an efficient graded index variation. The refractive index of Si₃N₄ lies between that of Si and SiO₂, thus a 350 nm layer of Si₃N₄ may be seen to enhance the optical coupling by over 10% as it may facilitate a graded increase in the optical effective index from SiO₂ to Si. In some embodiments, since the design may be optimized using a derivative free method numerically, it may be important to determine the performance reliance of the coupler in the neighborhood of the optimized values. This will be briefly discussed in a later section.

### Distributed Bragg Reflector

In some embodiments, light coupled to the transmitted diffraction orders may then be reflected back onto the grating coupler using an all dielectric DBR mirror. The working of a DBR mirror may be modeled using the Redheffer Star product approach of modeling the response of a multilayer device to a single scattering matrix. The algorithm may use a two-stage process of a forward pass, followed by a backward pass wherein for each layer, the mode coefficients cᵢ⁺ and cᵢ⁻, the modal fields Wᵢ and Vᵢ are computed in an iterative process. The electric and magnetic fields in the ith layer are given as in Equation 5, below:

$$[ \begin{matrix}{E}_{x , i} ( {z}_{i} ) \\ {E}_{y , i} ( {z}_{i} ) \\ {H}_{x , i} ( {z}_{i} ) \\ {H}_{y , i} ( {z}_{i} )\end{matrix} ] = [ \begin{matrix}{W}_{i} & {W}_{i} \\ {V}_{i} & - {V}_{i}\end{matrix} ] [ \begin{matrix}{e}^{{λ}_{i} {z}_{i}} & 0 \\ 0 & {e}^{- {λ}_{i} {z}_{i}}\end{matrix} ] [ \begin{matrix}{c}_{i}^{+} \\ {c}_{i}^{-}\end{matrix} ] \qquad ( 5 )$$

The optimal thicknesses of SiO₂ and silicon nitride corresponding to maximal reflectivity may then be computed using the pattern search algorithm. For some embodiments, it was found that 10 layers of 513 nm SiO₂ paired with 369 nm of Si₃N₄ may give a combined reflectance of up to 98.7% to unpolarized light. The specular reflection may cause a recouping of light to the grating, where the angle of incidence of light on the grating may be slightly different from the optimal angle designed earlier, which may reduce the coupling efficiency of the second reflection to 54.6%.

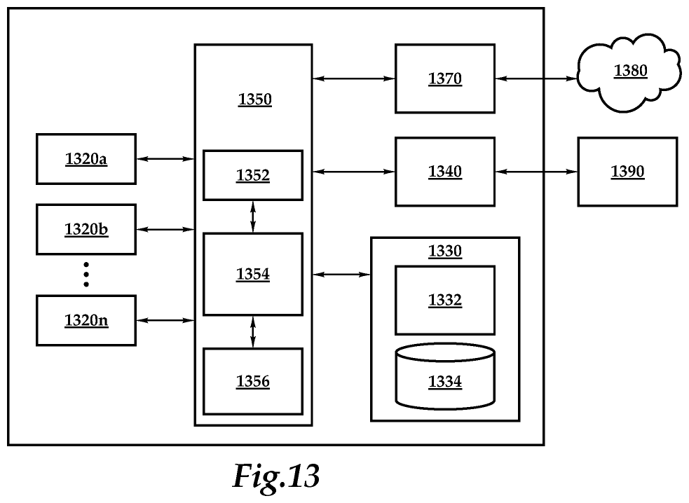

FIG. 14 depicts graphs 1400 and 1450 of layer thickness for an exemplary BOC. In graph 1400, the layer thickness of DBR mirror layers were computed using the pattern search algorithm, and optimized point corresponding to the thickness of individual layers is shown as a histogram with the iteration number along x-axis 1401 and the values of −|R| (e.g., negative absolute value of reflectance) along y-axis 1402. In graph 1450, the convergence plot also shows that the design values are tolerant to fabrication errors, with variables (e.g., box 1543 representing SiO₂ and box 1544 representing Si₃N₄) along x-axis 1451 and layer thickness in μm along y-axis 1452.

In FIG. 14, the optimized objective value and the optimized variable values corresponding to the same are depicted. In order to solve for the optimization, the problem was converted to a minimization problem where −|R| was minimized as required by the global optimization toolbox in matlab R2022b for two input variables corresponding to the thickness of the two layers, although other optimization algorithms may be used.

In Table 2, below, shows various values of Si₃N₄ thickness and their respective coupling efficiencies, as determined by simulation, such as those whose results are also depicted in FIG. 14.

TABLE 2
Coupling Efficiency as a Function Si₃N₄
Layer Thickness

| | | | |
|---|---|---|---|
| Si₃N₄ Layer | 0 | 50 | 350 |
| Thickness in nm | | | |
| Coupling | 39.30 | 41.7 | 45.25 |
| Efficiency % | | | |

### Performance Analysis

While the preceding section covers the design and optimizations aspects of some embodiments of the backside optical coupler, here performance of some embodiments of the backside optical coupler are discussed. While edge couplers have shown low polarization dependent losses (PDL) and low wavelength dependent losses, as compared to grating couplers, other design strategies have been proposed to mitigate these losses in grating couplers. Various designs and polarization diversity schemes may be employed to reduce the PDL in grating couplers, and, in some embodiments, the backside optical coupler architecture is amenable to such designs. Results are reported for the embodiment of the BOC design discussed above. From simulation results, it may be shown that both bandwidth and polarization metrics appear promising and competitive to other technologies.

### Bandwidth

In some embodiments, the BOC design may be targeted towards the C-Band, in line with the fiber characteristics. The design may be optimized using the particle swarm algorithm for a central wavelength of 1550 nm. The refractive index of Si₃N₄ (e.g., n=1.99) in this range falls between that of the SiO₂ BOX layer and the Si grating structure, which may allow for a graded transition in the effective index. Importantly, the material properties may remain largely uniform over the entire band, which may simplify the problem by limiting the variation to waveguide dispersion.

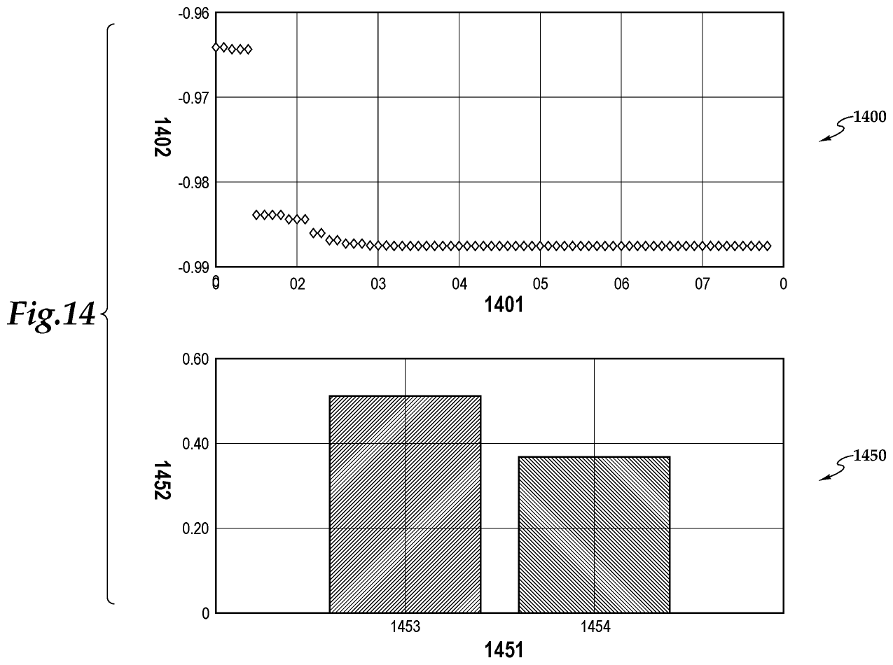

FIG. 15 depicts a graph 1500 of coupling efficiency versus wavelength for an exemplary BOC. The graph 1500 depicts the coupling efficiency along y-axis 1502 as a function of wavelength in m*10⁶ along x-axis 1501 for TE as line 1504 and for TM as line 1503. The C-band is indicated by double headed error 1505.

The plot in FIG. 15 shows that the wavelength dependent loss of the BOC may be less than 1 dB over the entire C-band. Narrow resonance peaks within the band may be attributed to constructive and destructive interference of light within different material layers. In some embodiments, these narrow resonance peaks may be suppressed by surface roughness of the different layers.

### Polarization Dependent Loss

As discussed previously, realizing low polarization dependent loss may be a challenge for grating couplers. In some embodiments, various approaches developed to tackle high or polarization dependent loss-such as diversity schemes with gratings being split across the two axes to deal with the two orthogonal polarization states or superimposed dual grating designs—may be applied in the BOC. PDL and its range may be determined, such as to add in optimization of design for either of the two polarization states. The preceding paragraphs have been concerned with parameters optimized for the TE polarization state, such as the angle of incidence, pitch and the duty cycle of the grating, thickness of the Si₃N₄ and the TOX layer. In some embodiments, the efficiency drop for TM polarization may be observed to be 10% to −1.3 dB. In some embodiments, optimizing the design parameters for the TM polarization may yield a peak coupling efficiency of −1.1 dB with a PDL of ˜.63 dB. The optical fiber may be a low contrast waveguide and may be modeled under a scalar approximation. The scalar field likewise may be approximated to the TE mode of the waveguide. Under the TE mode optimization of the BOC, the coupling of light from the fiber to the PIC may be efficient, but the reverse may be heavily impacted by the PDL.

### Fabrication Tolerance

Fabrications inaccuracies, non-ideal environmental conditions and deficiencies in the mathematical modeling to effectively account for real world conditions may often lead to promising designs which may have underwhelming performance metrics when fabricated. In an effort to bridge the gap between modeling and fabrication, the vulnerability of the proposed optical coupler may be studied to gauge any possible deviation from the performance metrics for potentially realized structures. The grating structure may have multiple parameters which may be optimized for efficient coupling.

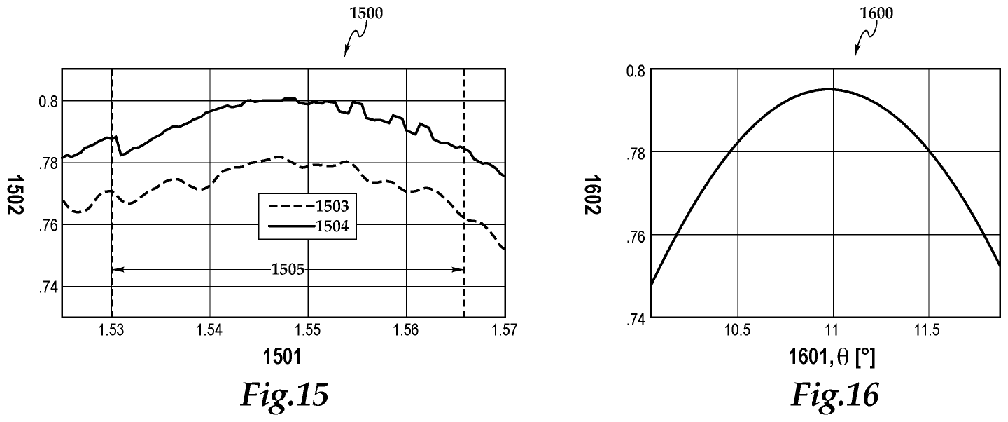

FIG. 16 depicts a graph 1600 of coupling efficiency versus the angle of incidence on the grating for an exemplary BOC. The graph 1600 depicts coupling efficiency on y-axis 1602 as a function of angle of incidence along x-axis 1601. In some embodiments, the fiber-cut angle which affects the angle of incidence on the V-groove may be substantially resilient to fabrication errors.

In FIG. 16, the optimal incident angle varies from 10° to 12° about the optimal central angle of 11°. This angle variation may translate to inaccuracies in the fiber cuts. It may be observed that the grating design is reasonably tolerant to angled fiber cut inaccuracies within a degree.

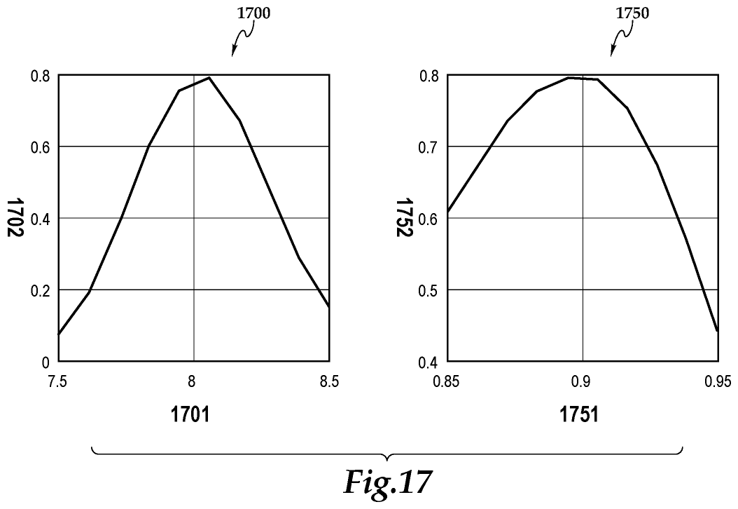

The pitch and the duty-cycle of a grating may be its primary characteristics. Inaccuracies in the grating design may result in variations in the pitch and duty cycles over different grating periods or deviation of a said pitch and duty cycle during the fabrication process. The tolerance of the proposed design to fabrication imperfection in realizing the grating was studied and is plotted in FIG. 17.

FIG. 17 depicts graphs 1700 and 1750 of coupling efficiency versus grating pitch and grating duty cycle, respectively, for an exemplary BOC. The graph 1700 depicts coupling efficiency along y-axis 1702 as a function of grating pitch in m*10⁻⁷ along x-axis 1701. The graph 1750 depicts coupling efficiency along y-axis 1752 as a function of grating duty cycle along x-axis 1751. As shown in graph 1700, the grating parameters may be sensitive and may require high fabrication accuracy. The coupling efficiency may be seen to fall drastically with changes in the pitch of the grating, while the duty cycle may be relatively resilient to fabrication imperfections, as shown in graph 1750. It can be seen that both these parameters may function optimally with 10 s of nanometer precision and may be highly sensitive to design variations. In some embodiments, it will be possible to fabricate such accurate grating designs using the current foundry capabilities.

Some of the other relevant fabrication parameters include the inaccuracies in the thickness of layers of the DBR mirrors and the thickness of the Si₃N₄ layer, where the effect of the thickness of these layers was previously discussed. For some embodiments, the design was observed to the largely tolerant to fabrications imperfections.

In some embodiments, the BOC may represent a fiber density improvement over other optical I/O devices, such as edge couplers and front side grating couplers. In some embodiments, input density may be limited by fiber spacing, such as to ˜125 mm spacing representing optical fiber sizes. In some embodiments, output density may depend on waveguide spacing, which may be as close as ˜1 mm. In some embodiments, grating couplers may be “area” couplers, in which an input area (e.g., of the grating) is coupled to a substantially one-dimensional waveguide (e.g., area in to line out). In some embodiments, this may lead to space saving and capacity increase for optical I/O. The area advantage can be mapped to the linear spacing at the output.

Some embodiments of an optical I/O are presented which couple light from the substrate side of the wafer. This approach may offer a clutter free area for device integration on the top side of the wafer. In some embodiments, the BOC design includes a V-groove fiber housing array to provide ultra-high density with mechanical stability. The backside optical coupler may employ an efficient rib waveguide grating formed by despositing Si₃N₄ on a Si/SiO₂ grating structure for the coupling mechanism while containing the light using an all-dielectric Distributed Bragg Mirror. In some embodiments, the BOC may offer flexibility to implement novel grating coupling schemes to improve the coupling efficiency for different wavelength ranges and for suppression of polarization dependent losses. In some embodiments, the BOC approach may be used to mainstream grating couplers for efficient optical I/Os.

While various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system may be transmitted to computer system via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art of reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

Grouped, numerated embodiments are listed below by way of example. Reference to prior characterizations of embodiments within are within each group.

### Embodiments

1. An optical coupler comprising: an optical fiber housing, the housing configured to accept one or more optical fiber pigtails and the housing mechanically coupled to a backside of an integrated circuit chip; a grating coupler, the grating coupler optically coupled to an output of the one or more optical fiber pigtails of the optical fiber housing; ana waveguide, the waveguide optically coupled to an output of the grating coupler.
2. The optical coupler of embodiment 1, wherein the housing is configured to accept the one or more optical fibers pigtails in a V-groove or frustum of the integrated circuit chip, and wherein the one or more optical fiber pigtails are substantially perpendicular or substantially oblique to a longitudinal plane of the integrated circuit chip.
3. The optical coupler of embodiment 2, wherein the V-groove or frustum comprises a graded portion and an adiabatic taper portion, and wherein the one or more optical fibers comprises multiple single mode optical fibers.
4. The optical coupler of embodiment 1, wherein the waveguide is at least one of a rib waveguide, a ridge waveguide, or a combination thereof optically coupled to the output of the grating coupler.
5. The optical coupler of embodiment 1, wherein the grating coupler is a parallel grating and the waveguide further comprises a power combiner/splitter.
6. The optical coupler of embodiment 1, wherein the grating coupler is a focusing or curved grating.
7. The optical coupler of embodiment 1, further comprising an anti-reflective layer, wherein the anti-reflective layer is substantially opposite the grating coupler from the optical fiber housing.
8. The optical coupler of embodiment 7, wherein the anti-reflective layer comprises one or more distributed Bragg reflector (DBR) mirrors.
9. The optical coupler of embodiments 7 or 8, wherein the anti-reflective layer comprises one or more metamaterial structures or layer.
10. The optical coupler of embodiment 1, further comprising metamaterial structures, wherein the metamaterial structures are configured to reflect transmission modes of the grating coupler.
11. The optical coupler of embodiment 1, wherein the grating coupler is a focusing grating.
13. The optical coupler of embodiment 1, further comprising further comprising a bottom anti-reflective layer, wherein the bottom anti-reflective layer is substantially parallel to a longitudinal plane of the grating coupler and wherein the optical fiber housing passes through the bottom anti-reflective layer.
14. The optical coupler of embodiment 1, wherein the integrated circuit chip is a silicon on insulator (SOI) or aluminum nitride on sapphire chip or co-packaged optics for a SOI or aluminum nitride on sapphire chip.
15. The optical coupler of embodiment 1, further integrated in a photonic integrated circuit (PIC), wherein the PIC is further integrated with at least one of a heat sink, heat spreaders, a laser, a packaging substrate, building layers, a redistribution layer, and a combination thereof.
16. The optical coupler of embodiment 14, wherein the integration in the PIC is monolithic integration and wherein the integration of the PIC with the at least one of a heat sink, heat spreaders, a laser, a packaging substrate, building layers, a redistribution layer, and a combination thereof is heterogeneous.
17. The optical coupler of embodiment 15, wherein the PIC is electrically connected to the at least one of a heat sink, heat spreaders, a laser, a packaging substrate, building layers, a redistribution layer, and a combination thereof is heterogeneous.
18. The optical coupler of embodiment 14, further comprising one or more optical fibers accepted by the housing.
19. The optical coupler of embodiment 17, wherein the one or more optical fibers are configured to supply optical signals to the PIC.
20. The optical coupler of embodiment 1, further comprising co-packaged optics.
21. The optical coupler of embodiment 19, wherein the co-packaged optics comprises at least one of a PIC, a redistribution layer, memory, metal connection layer, through silicon via (TSV), interposer, or a combination thereof.
22. The optical coupler of embodiment 20, wherein the metal connection layer comprises at least one of copper bumps, solder bumps, solder balls, bump metallization, or a combination thereof.
23. The optical coupler of embodiment 20, further comprising one or more optical fibers accepted by the housing and an optical input/output interface in communication with the one or more optical fibers.
24. The optical coupler of embodiment 1, further comprising electro-optical transducer, wherein the electro-optical transducer is optically coupled with the waveguide.
25. The optical coupler of embodiment 23, further comprising an interposer, wherein the interposer electrically connects one or more circuits to an output of the electro-optical transducer.
26. The optical coupler of embodiment 24, wherein the interposer electrically connects one or more qubit to the electro-optical transducer.
27. A method of fabricating the optical coupler of any one of embodiments 1 to 25.
28. A method of fabricating an optical coupler, comprising: fabricating a waveguide on a substrate; fabricating a grating coupler on a substrate, the grating coupler optically coupled to the waveguide; depositing a cladding layer on the grating coupler; and etching a V-groove or frustum on a backside of the substrate.
29. The method of embodiment 27, further comprising: fabricating one or more antireflective layers on the cladding layer.
30. The method of embodiment 27, further comprising fabricating one or more distributed Bragg reflector (DBR) on the cladding layer.
31. The method of embodiment 27, wherein etching the V-groove or frustum on the backside of the substrate further comprises bonding one or more optical fiber to the backside of the substrate.
32. The method of embodiment 30, wherein bonding one or more optical fiber to the backside of the substrate further comprises: underfilling the V-groove or frustum; inserting the one or more optical fiber into the underfilled V-groove or frustum; and filling the V-groove or frustum.
33. The method of embodiment 31, wherein the V-groove or frustum is filled with at least one of a polymer, silicon dioxide, and a combination thereof.
34. The method of embodiment 27, further comprising fabricating an opto-electronic transducer on the substrate, the opto-electronic transducer optically coupled to the waveguide.
35. A method of operating the optical coupler of any one of embodiments 1 to 25.
36. A method of transmitting an optical signal, comprising: transmitting an optical signal to an optical coupler via a first optical fiber, the optical coupler comprising: an optical fiber housing, the housing configured to accept one or more optical fiber pigtails, at least one of the optical fiber pigtails corresponding to the first optical fiber, and the housing mechanically coupled to a backside of an integrated circuit chip; a grating coupler, the grating coupler optically coupled to an output of the one or more optical fiber pigtails of the optical fiber housing; and a waveguide, the waveguide optically coupled to an output of the grating coupler; and receiving the optical signal via the waveguide.

What is claimed is:

1. An optical coupler comprising:
an optical fiber housing, the housing configured to accept one or more optical fiber pigtails and the housing mechanically coupled to a backside of an integrated circuit chip;
a grating coupler, the grating coupler optically coupled to an output of the one or more optical fiber pigtails of the optical fiber housing; and
a waveguide, the waveguide optically coupled to an output of the grating coupler.

2. The optical coupler of claim 1, wherein the housing is configured to accept the one or more optical fibers pigtails in a V-groove or frustum of the integrated circuit chip, and wherein the one or more optical fiber pigtails are substantially perpendicular or substantially oblique to a longitudinal plane of the integrated circuit chip.

3. The optical coupler of claim 2, wherein the V-groove or frustum comprises a graded portion and an adiabatic taper portion, and wherein the one or more optical fibers comprises multiple single mode optical fibers.

4. The optical coupler of claim 1, wherein the waveguide is at least one of a rib waveguide, a ridge waveguide, or a combination thereof optically coupled to the output of the grating coupler.

5. The optical coupler of claim 1, wherein the grating coupler is a parallel grating and the waveguide further comprises a power combiner/splitter.

6. The optical coupler of claim 1, wherein the grating coupler is a focusing or curved grating.

7. The optical coupler of claim 1, further comprising an anti-reflective layer, wherein the anti-reflective layer is substantially opposite the grating coupler from the optical fiber housing.

8. The optical coupler of claim 7, wherein the anti-reflective layer comprises one or more distributed Bragg reflector (DBR) mirrors and/or one or more metamaterial structures or layer.

9. The optical coupler of claim 1, further comprising metamaterial structures, wherein the metamaterial structures are configured to reflect transmission modes of the grating coupler.

10. The optical coupler of claim 1, wherein the grating coupler is a focusing grating.

11. The optical coupler of claim 1, further comprising further comprising a bottom anti-reflective layer, wherein the bottom anti-reflective layer is substantially parallel to a longitudinal plane of the grating coupler and wherein the optical fiber housing passes through the bottom anti-reflective layer.

12. The optical coupler of claim 1, wherein the integrated circuit chip is a silicon on insulator (SOI) or aluminum nitride on sapphire chip or co-packaged optics for a SOI or aluminum nitride on sapphire chip.

13. The optical coupler of claim 1, further integrated in a photonic integrated circuit (PIC), wherein the PIC is further integrated with at least one of a heat sink, heat spreaders, a laser, a packaging substrate, building layers, a redistribution layer, and a combination thereof.

14. The optical coupler of claim 13, wherein the integration in the PIC is monolithic integration, wherein the integration of the PIC with the at least one of a heat sink, heat spreaders, a laser, a packaging substrate, building layers, a redistribution layer, and a combination thereof is heterogeneous, and wherein the PIC is electrically connected to the at least one of a heat sink, heat spreaders, a laser, a packaging substrate, building layers, a redistribution layer, and the combination thereof.

15. The optical coupler of claim 13, further comprising one or more optical fibers accepted by the housing and wherein the one or more optical fibers are configured to supply optical signals to the PIC.

16. The optical coupler of claim 1, further comprising co-packaged optics, the co-packaged optics comprising at least one of a PIC, a redistribution layer, memory, metal connection layer, through silicon via (TSV), interposer, or a combination thereof, and one or more optical fibers accepted by the housing and an optical input/output interface in communication with the one or more optical fibers.

17. The optical coupler of claim 16, wherein the metal connection layer comprises at least one of copper bumps, solder bumps, solder balls, bump metallization, or a combination thereof.

18. The optical coupler of claim 1, further comprising electro-optical transducer, wherein the electro-optical transducer is optically coupled with the waveguide, and an interposer, wherein the interposer electrically connects one or more circuits to an output of the electro-optical transducer, wherein the interposer electrically connects one or more qubits to the electro-optical transducer.

19. A method of fabricating an optical coupler, comprising:
fabricating a waveguide on a substrate;
fabricating a grating coupler on a substrate, the grating coupler optically coupled to the waveguide;
depositing a cladding layer on the grating coupler; and
etching a V-groove or frustum on a backside of the substrate.

20. A method of transmitting an optical signal, comprising:
transmitting an optical signal to an optical coupler via a first optical fiber, the optical coupler comprising:
an optical fiber housing, the housing configured to accept one or more optical fiber pigtails, at least one of the optical fiber pigtails corresponding to the first optical fiber, and the housing mechanically coupled to a backside of an integrated circuit chip;
a grating coupler, the grating coupler optically coupled to an output of the one or more optical fiber pigtails of the optical fiber housing; and
a waveguide, the waveguide optically coupled to an output of the grating coupler; and
receiving the optical signal via the waveguide.
